(19) United States
(12) Patent Application Publication
(10) Pub. No.: US 2014/0375138 A1
(43) Pub. Date: Dec. 25, 2014

(54) POWER SUPPLY DEVICE, POWER RECEIVING DEVICE, AND PROGRAM

(71) Applicant: Sony Corporation, Tokyo (JP)

(72) Inventors: Yoichiro Sako, Tokyo (JP); Takanori Washiro, Kanagawa (JP); Kazuyoshi Takemura, Tokyo (JP); Kuniya Hayashi, Tokyo (JP); Isao Soma, Saitama (JP); Kayoko Tanaka, Tokyo (JP); Satoshi Higano, Kanagawa (JP); Kazutoshi Serita, Tokyo (JP)

(73) Assignee: Sony Corporation, Tokyo (JP)

(21) Appl. No.: 14/376,170

(22) PCT Filed: Jan. 28, 2013
(86) PCT No.: PCT/JP2013/000429

§ 371 Date: Aug. 1, 2014

(30) Foreign Application Priority Data
Feb. 10, 2012 (JP) 2012-027485

(51) Int. Cl. H04B 3/54; H02J 17/00; B60L 11/18; H02J 13/00

(52) U.S. Cl. CPC H04B 3/54; H02J 13/00; H02J 17/00; B60L 11/18
USPC 307/104

(57) ABSTRACT

Devices, methods, and programs for providing a notice indicating whether a device supports an authentication function. A method for providing notice may include performing communication with a device, making a determination whether the device is a power supply target, selectively transmitting power to the device based on a result of the determination, and providing a notice indicating whether the device supports an authentication function based on the result of the determination. A power supply device may include a communication unit, a determining unit, a power control unit, and a notice control unit. Another method for providing notice may include performing communication with a device, and providing a notice indicating whether the power supply device supports the authentication function based on a result of the communication. A power receiving device may include a communication unit and a notifying unit.

### TECHNICAL FIELD

The present disclosure relates to a power supply device, a power receiving device, and a program.

The present application builds upon concepts disclosed in prior applications by one or more of the inventors and/or the assignee, including the following: Japan Patent Application No. 2012-027485, titled “Identification for a power connector including identification function,” filed Feb. 10, 2012. The entire contents of each of the above-identified applications are hereby incorporated by reference.

### BACKGROUND ART

In recent years, devices capable of performing authentication on a device of a power supply target such as a power supply device for a vehicle, for example, an electric vehicle (EV), and selectively supplying the device of the power supply target with power according to an authentication result have been released. In addition, a technique of performing an authentication or accounting process using power line communication has been developed. For example, as a technique of performing an authentication or accounting process using power line communication, there is a technique discussed in Patent Literature 1.

### CITATION LIST

### Patent Literature

PTL 1: JP 2006-262570 A

### SUMMARY

### Technical Problem

A device (for example, a transmission side device (hereinafter referred to as a “power supply device”)) that has an authentication function and performs power supply based on an authentication result or a device at a reception side (hereinafter referred to as a “power receiving device”) have not been standardized yet. For this reason, it is likely to be difficult for a user to determine whether or not, for example, a power receiving device connected to a power supply device or a power supply device connecting a power receiving device is a device that performs power supply based on the authentication result.

The present disclosure is directed to propose a power supply device, a power receiving device, and a program, which are new and novel and capable of notifying a user of whether or not an external device connected using a power line supports a predetermined authentication function.

### Solution to Problem

According to an embodiment of the present disclosure, there is provided a power supply device, including: a communication unit for performing communication with a power receiving device, wherein performing the communication includes transmitting a transmission signal to the device; a determining unit for making a determination whether the device is a power supply target, based on a result of the communication; a power control unit for controlling selective transmission of power from a power supply unit to the device via a power line; and a notice control unit for controlling provision of a notice indicating whether the device supports a predetermined authentication function.

In some embodiments, performing the communication with the device further includes receiving a response signal, the device providing the response signal by performing load modulation based on the transmission signal.

According to an embodiment of the present disclosure, there is provided a method including: performing communication with a device, wherein performing the communication includes transmitting a transmission signal to the device; based on a result of the communication, making a determination whether the device is a power supply target; based on a result of the determination, selectively transmitting power from a power source to the device; and based on the result of the determination, providing a notice indicating whether the device supports a predetermined authentication function.

According to an embodiment of the present disclosure, there is provided a power receiving device, including: a communication unit for performing communication with a power supply device, wherein performing the communication includes determining whether the power supply device supports a predetermined authentication function; and a notifying unit configured to provide a notice indicating whether the power supply device supports the predetermined authentication function, based on a result of the communication.

According to an embodiment of the present disclosure, there is provided a method including: performing communication with a power supply device, wherein performing the communication includes determining whether the power supply device supports a predetermined authentication function; based on a result of the communication, providing a notice indicating whether the power supply device supports the predetermined authentication function.

### BRIEF DESCRIPTION OF DRAWINGS

FIG. 1 is a flowchart illustrating an example of a process related to a notice control method in a power supply device according to the present embodiment.

FIG. 2 is a flowchart illustrating an example of a process related to a notice control method in a power receiving device according to the present embodiment.

FIG. 3 is an explanatory diagram for describing an example of wireless communication according to the present embodiment.

FIG. 4 is an explanatory diagram illustrating an example of a configuration for implementing wireless communication performed between a power supply device according to the present embodiment and a power receiving device according to the present embodiment.

FIG. 5 is an explanatory diagram for describing an example of power line communication of the present embodiment.

FIG. 6 is an explanatory diagram illustrating an example of a configuration of a power line communication unit arranged in a power supply device according to the present embodiment.

FIG. 7 is an explanatory diagram illustrating another example of a power line communication unit arranged in a power supply device according to the present embodiment.

FIG. 8 is an explanatory diagram illustrating an example of a configuration of a first filter arranged in a power supply device according to the present embodiment.

FIG. 9 is an explanatory diagram illustrating an example of a configuration of a second filter arranged in a power supply device according to the present embodiment.

FIG. 10 is an explanatory diagram illustrating an example of a configuration of a power line communication unit arranged in a power receiving device according to the present embodiment.

FIG. 11 is an explanatory diagram illustrating another example of a configuration of a power line communication unit arranged in a power receiving device according to the present embodiment.

FIG. 12 is an explanatory diagram illustrating an example of configurations of a power supply device according to the present embodiment and a power receiving device according to the present embodiment.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, a description will proceed in the following order.

1. Notice Control Method According to Present Embodiment

2. Communication According to Present Embodiment

3. Power Supply Device and Power Receiving Device According to Present Embodiment

4. Program According to Present Embodiment

(Notice Control Method According to Present Embodiment)

Before describing configurations of a power supply device and a power receiving device according to the present embodiment, first a notice control method according to the present embodiment will be described.

As described above, a device that performs power supply based on an authentication result has not been standardized yet. For this reason, it is likely to be difficult for a user to determine whether or not, for example, a power receiving device connected to a power supply device or a power supply device connecting a power receiving device is a device that performs power supply based on an authentication result.

1. Notice Control Method in Power Supply Device According to Present Embodiment

In this regard, the power supply device according to the present embodiment performs communication with an external device (which corresponds to a power receiving device and may be hereinafter referred to as an “external connection device”) connected using a power line in a wired manner, and determines whether or not the external connection device is an external device of a power supply target (a determination process). In addition, the power supply device according to the present embodiment selectively transmits electric power to the external connection device when it is determined that the external connection device is the external device of the power supply target (a power control process). Further, the power supply device according to the present embodiment makes a notice based on the determination result (a notice control process).

(1) Determination Process

The power supply device according to the present embodiment, for example, determines whether or not the external connection device is the external device of the power supply target based on a communication result and an authentication result of the external connection device which is based on identification information when the identification information is acquired from the external connection device.

Here, the identification information according to the present embodiment refers to information which may be used to identify the external connection device. For example, examples of the identification information according to the present embodiment include data representing an identification number specific to the external connection device, data (for example, data representing a manufacturer, a model number, or the like) representing the type of external connection device, and power waveform data representing a power waveform when the external connection device is used (the external connection device is driven). The identification information according to the present embodiment is not limited to the above examples as far as the information may be used for identification of the external connection device.

Here, in the case in which it is determined whether or not the external connection device is the external device of the power supply target based on a communication result, the power supply device according to the present embodiment determines that the external device is not the external device of the power supply target, for example, when communication with the external connection device is not performed or when identification information is not acquired from the external connection device.

Further, when the identification information is acquired from the external connection device through communication with the external connection device, the power supply device according to the present embodiment performs authentication based on the identification information. For example, the power supply device according to the present embodiment performs authentication on the external connection device based on whether or not identification information corresponding to the identification information acquired from the external connection device remains stored in a database in which the identification information representing the external device of the power supply target is recorded. Here, the database may be stored in a recording medium such as a storage unit (which will be described later) arranged in the power supply device according to the present embodiment, and the power supply device according to the present embodiment may acquire the database from an external device such as a server. Further, the power supply device according to the present embodiment, for example, determines that the external connection device is the external device of the power supply target when authentication has been performed normally, but determines that the external connection device is not the external device of the power supply target when authentication has not been performed normally.

Here, when it is determined that the external connection device is the external device of the power supply target, the power supply device according to the present embodiment authenticates the external connection device normally, as described above. In other words, the authentication based on the identification information according to the present embodiment may refer to a process of determining whether or not an authentication function (which may be hereinafter referred to as a “predetermined authentication function”) supported by its own device (the power supply device according to the present embodiment) is supported.

Thus, the power supply device according to the present embodiment can determine whether or not the external connection device has a predetermined authentication function by performing the process (1) (the determination process).

(2) Power Control Process

For example, when it is determined that the external connection device is the external device of the power supply target, the power supply device according to the present embodiment causes a power supply unit (which will be described later) that can selectively supply power to enter a power suppliable state. Thus, the power supply device according to the present embodiment can selectively transmit (supply) power to the external connection device having a predetermined authentication function by performing the process (2) (the power control process).

Further, for example, when it is determined that the external connection device is not the external device of the power supply target, that is, when the external connection device does not have a predetermined authentication function, the power supply device according to the present embodiment causes the power supply unit (which will be described later) not to enter the power suppliable state. Thus, the power supply device according to the present embodiment can limit transmission of power (supply of power) to an external connection device having no predetermined authentication function, that is, an unauthorized external connection device (from a point of view of a predetermined authentication function) by performing the process (2) (the power control process).

(3) Notice Control Process

The power supply device according to the present embodiment causes, for example, a notifying unit (which will be described later) arranged in the power supply device according to the present embodiment to make a notice based on the determination result in the process (1) (the determination process), and/or causes an external device such as the external connection device to make a notice based on the determination result.

As a notice method according to the present embodiment, for example, a method of appealing to the user's sense such as a visual notice method using text, an image, illumination of a lamp, or the like or an acoustical notice method using a sound (including music or a beep sound; the same applies hereinafter) may be included. More specifically, for example, a method of turning on a lamp corresponding to notice content among lamps of a plurality of colors each corresponding to notice content or a method of changing a blinking method of a lamp corresponding to notice content (an example of the visual notice method) may be used as the notice method according to the present embodiment. Further, for example, a method of reproducing a sound corresponding to notice content among sounds each corresponding to notice content (an example of the acoustical notice method) may be used as the notice method according to the present embodiment.

Here, as the notice based on the determination result in the process (1) (the determination process), the power supply device according to the present embodiment makes different notices, for example, when it is determined that the external connection device is the external device of the power supply target and when it is determined that the external connection device is not the external device of the power supply target. As the different notices according to the present embodiment, for example, the power supply device according to the present embodiment makes different notices when it is determined that the external connection device is the external device of the power supply target and when it is determined that the external connection device is not the external device of the power supply target. For example, the power supply device according to the present embodiment notifies of a warning representing that the external connection device is not the external device of the power supply target or a warning representing that the external connection device does not have a predetermined authentication function when it is determined that the external connection device is not the external device of the power supply target. Further, the power supply device according to the present embodiment, for example, notifies of the fact that power supply is performed normally or the fact that the external connection device has a predetermined authentication function when it is determined that the external connection device is the external device of the power supply target.

The different notices according to the present embodiment are not limited to the above examples. For example, the power supply device according to the present embodiment may make a notice, for example, either when it is determined that the external connection device is the external device of the power supply target or when it is determined that the external connection device is not the external device of the power supply target as the different notice according to the present embodiment.

In addition, the power supply device according to the present embodiment can make a different notice according to the cause for which authentication has not been performed normally, for example, in the process (1) (the determination process). The authentication may not be performed normally in the process (1) (the determination process), for example, when communication with the connection target device is not performed, when it is difficult to acquire the identification information, when authentication is not performed normally due to the difference in an authentication format, or when the authentication format is normal but authentication is not completed normally.

The power supply device according to the present embodiment makes a notice based on the determination result in the process (1) (the determination process) by performing the process (3) (the notice control process). Thus, the power supply device according to the present embodiment performs the process (3) (the notice control process) and thus can notify the user of whether or not the external device (the external connection device) connected using a power line supports a predetermined authentication function.

In addition, as the power supply device according to the present embodiment notifies the user of whether or not the external device (the external connection device) connected using a power line supports a predetermined authentication function, the user can recognize whether or not the external device (the external connection device) connected using a power line supports a predetermined authentication function even in a situation in which the power receiving device with the authentication function has not been standardized. Thus, the power supply device according to the present embodiment can improve the user's convenience.

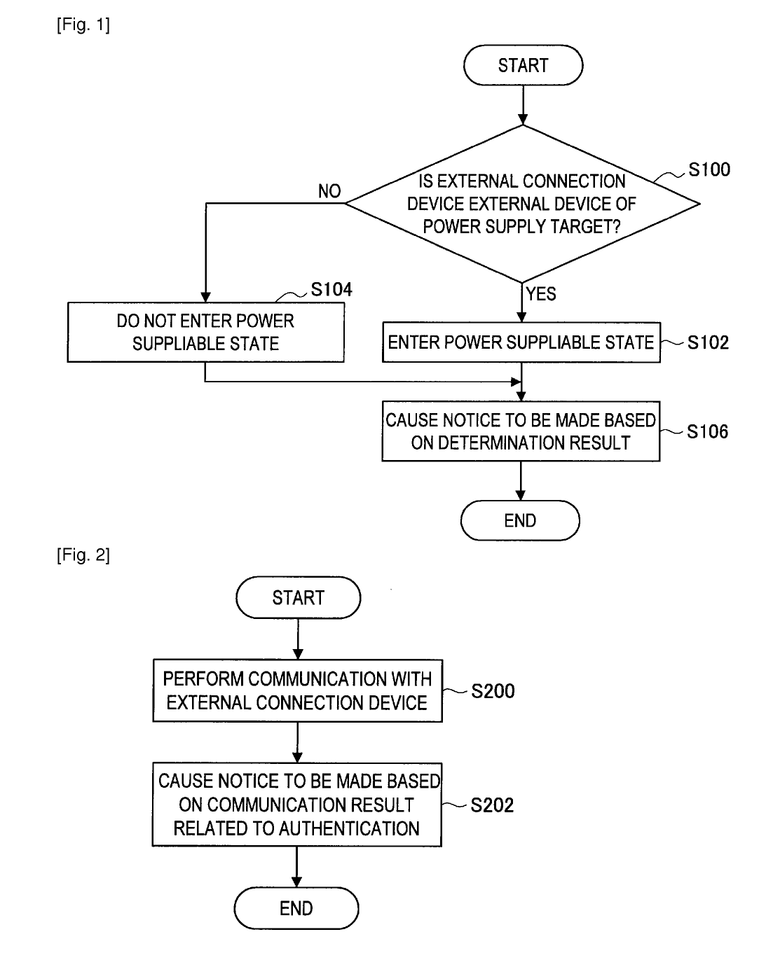

FIG. 1 is a flowchart illustrating an example of a process related to the notice control method in the power supply device according to the present embodiment. Here, the process of step S100 illustrated in FIG. 1 corresponds to the process (1) (the determination process), and the process of steps S102 and S104 illustrated in FIG. 1 corresponds to the process (2) (the power control process). Further, the process of step S106 illustrated in FIG. 1 corresponds to the process (3) (the notice control process).

The power supply device according to the present embodiment determines whether or not the external connection device is the external device of the power supply target (S100). For example, the power supply device according to the present embodiment performs the determination of step S100 based on the communication result with the external connection device and the authentication result of the external connection device which is based on identification information when the identification information is acquired from the external connection device.

Here, when it is determined in step S100 that the external connection device is the external device of the power supply target, the power supply device according to the present embodiment enters the power suppliable state (S102). However, when it is determined in step S100 that the external connection device is not the external device of the power supply target, the power supply device according to the present embodiment does not enter the power suppliable state (S104).

For example, the power supply device according to the present embodiment causes the notifying unit (which will be described later) arranged in the power supply device according to the present embodiment and/or the external device such as the external connection device to make a notice based on the determination result in step S100 (S106).

The power supply device according to the present embodiment performs, for example, the process illustrated in FIG. 1 as the process related to the notice control method.

The process related to the notice control method in the power supply device according to the present embodiment is not limited to the process illustrated in FIG. 1.

For example, FIG. 1 illustrates the example in which, after the process of step S102 or step S104 is performed, the process of step S106 is performed. However, the power supply device according to the present embodiment can independently perform the process of step S102 or S104 and the process of step S106. Thus, for example, the power supply device according to the present embodiment may perform the process of step S102 or S104 after the process of step S106 or may perform the process of step S106 in synchronization with the process of step S102 or S104.

2. Notice Control Method in Power Receiving Device According to Present Embodiment

The power receiving device according to the present embodiment performs communication with the external connection device (a communication process). In addition, the power receiving device according to the present embodiment makes a notice to the user based on a communication result (a result of communication related to authentication) related to authentication in the communication process (a notification process).

(I) Communication Process

For example, the power receiving device according to the present embodiment performs communication with the external connection device based on a connection to a power line. Here, an example of the communication based on the connection to the power line according to the present embodiment includes communication which is performed when the power receiving device according to the present embodiment receives a signal transmitted from the external connection device such as the power supply device according to the present embodiment according to a connection between the power receiving device according to the present embodiment and the power line. For example, when a connecting unit (which will be described later) arranged in the power receiving device according to the present embodiment has a function of detecting the connection to the power line, the power receiving device according to the present embodiment may perform communication which is based on the connection to the power line, based on a detection result in the connecting unit (which will be described later) arranged in the power receiving device according to the present embodiment. The communication process in the power receiving device according to the present embodiment is not limited to communication based on the connection to the power line. For example, the power receiving device according to the present embodiment can perform communication with the external connection device even in a state in which it is not connected to the power line.

More specifically, the power receiving device according to the present embodiment receives a signal (which may be hereinafter referred to as a “transmission signal”) transmitted from, for example, the external connection device, and performs a process related to communication. Then, the power receiving device according to the present embodiment transmits a response corresponding to the received transmission signal. Here, for example, the identification information, ACKnowledgement (ACK), or Negative ACKnowledgement (NACK) may be transmitted as the response according to the present embodiment. Further, for example, the transmission signal transmitted from the external connection device may be transmitted based on a transmission signal transmission request transmitted from the power receiving device according to the present embodiment.

Here, the power receiving device according to the present embodiment determines that communication related to authentication is performed, for example, when the received transmission signal includes an identification information transmission request to request transmission of the identification information or when the identification information is transmitted by load modulation according to the identification information transmission request. The power receiving device according to the present embodiment determines that communication related to authentication is not performed in a case other than, for example, a specific case in which it is determined that communication related to authentication is performed (for example, when the transmission signal is not received, when it is difficult to process the received transmission signal, or when the identification information transmission request is not received) as described above.

The power receiving device according to the present embodiment performs, for example, the above-described determination as a part of the communication process and thus can obtain the communication result representing that “the communication related to the authentication is performed.”

Here, when the communication result representing that “the communication related to the authentication is performed” is obtained, the external connection device connected to the power receiving device according to the present embodiment supports an authentication function (a predetermined authentication function) supported by its own device (the power receiving device according to the present embodiment). However, when the communication result representing that “the communication related to the authentication is performed” is not obtained, the external connection device connected to the power receiving device according to the present embodiment is unlikely to support a predetermined authentication function. Thus, as the process (I) (the communication process) is performed, the power receiving device according to the present embodiment can determine whether or not the external connection device has a predetermined authentication function.

(II) Notice Control Process

The power receiving device according to the present embodiment causes the notifying unit (which will be described later) arranged in the power receiving device according to the present embodiment and/or an external device to make a notice based on the communication result, for example, based on the communication result in the process (I) (the communication process). As the notice method in the power receiving device according to the present embodiment, similarly to the notice method in the power supply device according to the present embodiment, for example, a method of appealing to the user's sense such as a visual notice method using text, an image, illumination of a lamp, or the like or an acoustical notice method using a sound may be used.

Here, when the power receiving device according to the present embodiment can be driven by power obtained from the received transmission signal, the notification process is performed using power obtained by reception of the transmission signal. For example, when the transmission signal is not received or when it is difficult to obtain power from the received transmission signal and perform driving, the power receiving device according to the present embodiment performs the notification process, for example, using power transmitted through a power line from the external connection device or power obtained from an internal power source such as a battery.

The power receiving device according to the present embodiment makes a different notices, for example, when the communication result representing that “the communication related to the authentication is performed” is obtained, and when the communication result is not obtained as the notice based on the communication result related to the authentication in the process (I) (the communication process). As the different notices according to the present embodiment, for example, the power receiving device according to the present embodiment may make different notices when the communication result representing that “the communication related to the authentication is performed” is obtained and when the communication result is not obtained. Here, when the communication result representing that “the communication related to the authentication is performed” is obtained, for example, the power receiving device according to the present embodiment notifies of a warning representing the fact that the external connection device does not have a predetermined authentication function. However, when the communication result representing that “the communication related to the authentication is performed” is not obtained, for example, the power receiving device according to the present embodiment notifies of the fact that the external connection device has a predetermined authentication function.

The different notice according to the present embodiment is not limited to the above example. For example, the power receiving device according to the present embodiment may make a notice, for example, either when the communication result representing that “the communication related to the authentication is performed” is obtained or when the communication result is not obtained as the different notice according to the present embodiment.

The power receiving device according to the present embodiment performs the process (II) (the notice control process) to make the notice based on the communication result related to the authentication in the process (I) (the communication process). Thus, the power receiving device according to the present embodiment performs the process (II) (the notice control process) and thus can notify the user of whether or not the external device (the external connection device) connected using a power line supports a predetermined authentication function.

As the power receiving device according to the present embodiment notifies the user of whether or not the external device (the external connection device) connected using a power line supports a predetermined authentication function, the user can recognize whether or not external device (the external connection device) connected using a power line supports a predetermined authentication function even in a situation in which the power supply device having the authentication function has not been standardized. Thus, the power receiving device according to the present embodiment can improve the user's convenience.

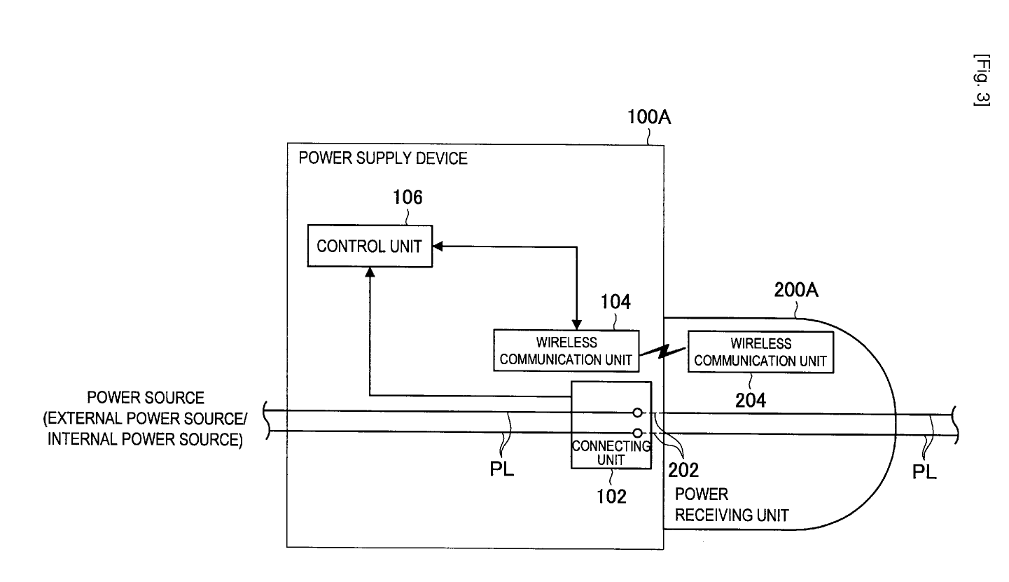

FIG. 2 is a flowchart illustrating an example of the process related to the notice control method in the power receiving device according to the present embodiment. Here, the process of step S200 illustrated in FIG. 2 corresponds to the process (I) (the communication process), and the process of step S202 illustrated in FIG. 2 corresponds to the process (II) (the notice control process).

The power receiving device according to the present embodiment performs communication with the external connection device (S200). The power receiving device according to the present embodiment determines whether or not the communication related to the authentication is performed, for example, based on the received transmission signal as a part of the process of step S200.

Here, when the process of step S200 is performed, the power receiving device according to the present embodiment causes, for example, the notifying unit (which will be described later) arranged in the power receiving device according to the present embodiment and/or the external device to make the notice based on the communication result related to the authentication (S202).

The power receiving device according to the present embodiment, for example, performs the process illustrated in FIG. 2 as the process related to the notice control method.

(Communication According to Present Embodiment)

Next, the description will proceed with communication performed between the power supply device according to the present embodiment and the power receiving device according to the present embodiment. For example, wireless communication or power line communication (wired communication) may be performed as communication between the power supply device according to the present embodiment and the power receiving device according to the present embodiment.

For example, wireless communication is performed between the power supply device according to the present embodiment and the power receiving device according to the present embodiment using a wireless communication technique such as a communication technique by a Near Field Communication (NFC) or Radio Frequency Identification (RFID) technique. Further, power line communication is performed between the power supply device according to the present embodiment and the power receiving device according to the present embodiment, for example, such that the wireless communication technique such as the communication technique by the NFC or RFID technique is applied to wired communication. Here, examples of the power line communication of the present embodiment include communication (so-called contact communication) performed between terminal of devices coming in contact with each other and communication performed when terminals of devices are connected to each other in a wired manner.

For example, the power supply device according to the present embodiment includes a high-frequency signal generating unit (which will be described later) that generates a high-frequency signal, and transmits the high-frequency signal to the external connection device. In other words, the power supply device according to the present embodiment has, for example, a so-called reader/writer function.

Further, the power receiving device according to the present embodiment, for example, performs communication with the external device by performing load modulation based on a signal transmitted from the external device such as the power supply device according to the present embodiment. For example, when the power receiving device according to the present embodiment receives the high-frequency signal transmitted from the power supply device according to the present embodiment, the power receiving device is driven by power obtained from the received highfrequency signal, performs the load modulation based on a result of processing the received high-frequency signal, and thus transmits the high-frequency signal.

For example, as the power supply device according to the present embodiment and the power receiving device according to the present embodiment perform the above-described processes, respectively, the wireless communication according to the present embodiment or the power line communication of the present embodiment is implemented between the power supply device according to the present embodiment and the power receiving device according to the present embodiment.

Here, examples of the high-frequency signal according to the present embodiment include a frequency signal used in RFID and a frequency signal used in non-contact communication. Examples of the frequency of the high-frequency signal include 130 to 135 [kHz], 13.56 [MHz], 56 [MHz], 433 [MHz], 954.2 [MHz], 954.8 [MHz], 2441.75 [MHz], and 2448.875 [MHz], but the frequency of the high-frequency signal according to the present embodiment is not limited to the above examples. In the following, a high frequency transmitted based on the high-frequency signal according to the present embodiment may be referred to as a “carrier wave.”

The wireless communication according to the present embodiment and the power line communication of the present embodiment are not limited to the communication using the wireless communication technique such as the communication technique by the NFC or the RFID technique. For example, a wireless communication of an arbitrary scheme such as wireless communication based on IEEE802.11b or power line communication such as PLC (Power Line Communication or power line carrier communication) may be performed between the power supply device according to the present embodiment and the power receiving device according to the present embodiment. In the following, the communication according to the present embodiment will be described in connection with an example in which communication using the wireless communication technique such as the communication technique by the NFC or RFID technique is performed between the power supply device according to the present embodiment and the power receiving device according to the present embodiment.

1. Wireless Communication According to Present Embodiment

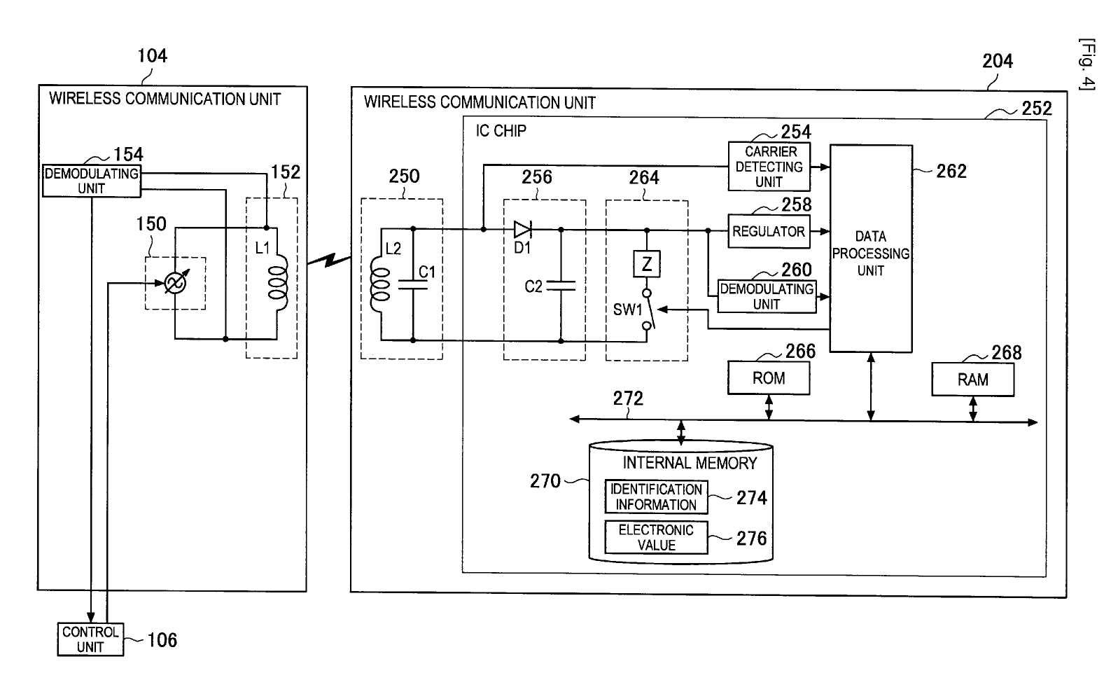

First, the wireless communication according to the present embodiment will be described. FIG. 3 is an explanatory diagram for describing an example of the wireless communication according to the present embodiment. In the following, the wireless communication according to the present embodiment will be described using a power supply device 100A and a power receiving device 200A illustrated in FIG. 3 as an example. In addition, FIG. 3 illustrates structural elements related to the wireless communication according to the present embodiment in a configuration of the power supply device according to the present embodiment and a configuration of the power receiving device according to the present embodiment. Further, FIG. 3 illustrates a plug as the power receiving device 200A, but the power receiving device according to the present embodiment is not limited to the plug.

For example, the power supply device 100A includes a connecting unit 102, a wireless communication unit 104, and a control unit 106. Further, for example, the power receiving device 200A includes a connecting unit 202 and a wireless communication unit 204.

The connecting unit 102 connects a power line PL through which power is transmitted to an external device. Further, the connecting unit 102 may include a connection supporting member that supports the maintenance of a connection state of the connected external device. Here, a power line through which an alternating current (AC) having a predetermined frequency such as 50 [Hz] or 60 [Hz] or a direct current (DC) flows may be used as the power line PL according to the present embodiment. Further, for example, a magnet may be used as the connection supporting member according to the present embodiment. In the following, the description will proceed in connection with an example in which an AC current having a predetermined frequency flows through the power line PL.

More specifically, the connecting unit 102 has a terminal connected to the power line PL, and the connecting unit 202 has a terminal connected to the power line PL (which corresponds to an external power line when seen from the power supply device 100A). Further, when the terminal of the connecting unit 102 is electrically connected to the terminal of the connecting unit 202, the power supply device 100A is connected to the power receiving device 200A (which corresponds to an external device when seen from the power supply device 100A). Here, an “electrical connection between the terminal of the connecting unit 102 and the terminal of the connecting unit 202” according to the present embodiment refers to, for example, a contact between the connecting units of the devices or a wired connection between the connecting units of the devices. In addition, the connecting unit 202 may include a connection supporting member that supports the maintenance of a connection state of the connected external device, similarly to the connecting unit 102 of the power supply device 100A.

For example, the connecting unit 102 detects a change in the connection state of the external device (a change from the non-connection state to the connection state or a change from the connection state to the non-connection state). Then, the connecting unit 102 transfers a detection signal representing the detection (detection result) to the control unit 106. In addition, when the wireless communication unit 104 has a function of transmitting the high-frequency signal in response to the transfer of the detection signal, the connecting unit 102 may transfer the detection signal to the wireless communication unit 104.

Here, for example, the connecting unit 102 includes a switch for detecting a physical connection state of the external device, and transfers the detection signal to the control unit 106 when a state of the switch changes. However, a configuration of the connecting unit 102 is not limited to this example. In addition, when the power supply device 100A is configured to transmit the high-frequency signal at regular intervals or irregular intervals, for example, the connecting unit 102 according to the present embodiment may not have a function of detecting a change in the connection state of the external device.

The wireless communication unit 104 and the wireless communication unit 204 undertake the wireless communication according to the present embodiment. Further, for example, the communication in the wireless communication unit 104 is controlled by the control unit 106.

The control unit 106 is constituted by a Micro Processing Unit (MPU) or an integrated circuit (IC) in which various kinds of processing circuits are integrated, and controls the components of the power supply device 100A. More specifically, for example, the control unit 106 transfers a high-frequency signal generation command or a high-frequency signal transmission stop command to a power line communication unit 108 based on the detection signal transferred from the connecting unit 102 or a response signal of the external connection device such as a power receiving device 200B transferred from the power line communication unit 108, and controls the communication in the power line communication unit 108.

Further, the control unit 106 actively undertakes the process (for example, the process (1) (the determination process) to the process (3) (the notice control process)) related to the notice control method according to the present embodiment. In the control unit 106 of the power supply device according to the present embodiment, a configuration for implementing the process related to the notice control method according to the present embodiment will be described later.

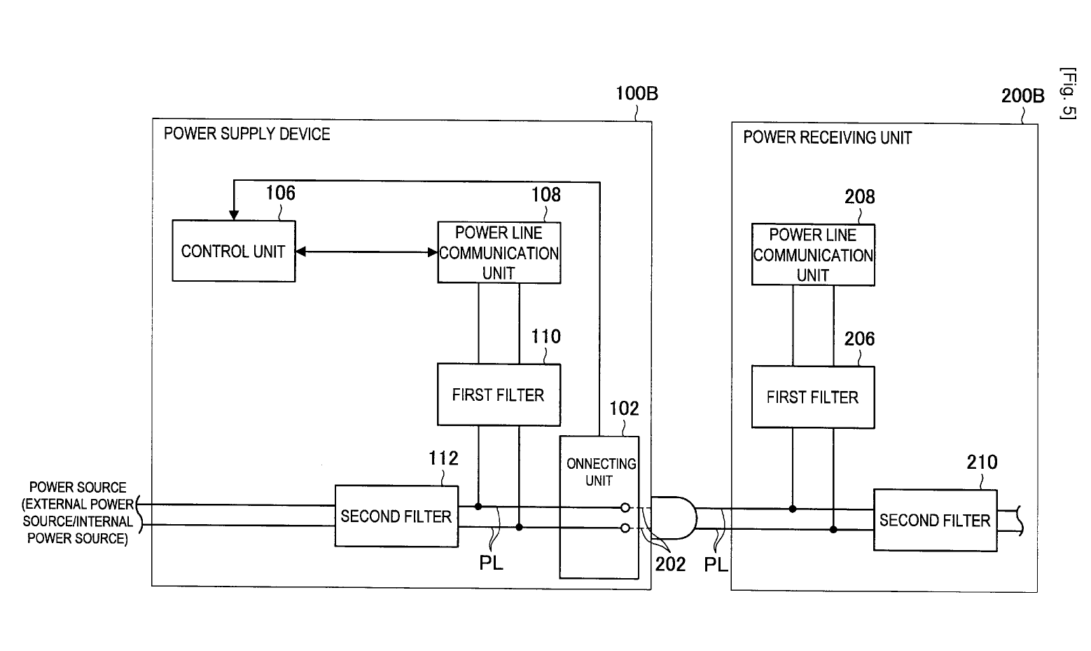

FIG. 4 is an explanatory diagram illustrating an example of a configuration for implementing wireless communication performed between the power supply device according to the present embodiment and the power receiving device according to the present embodiment. Here, FIG. 4 illustrates an example of configurations of the wireless communication unit 104 and the control unit 106 arranged in the power supply device 100A illustrated in FIG. 3 and the wireless communication unit 204 arranged in the power receiving device 200A illustrated in FIG. 3.

1-1. Wireless Communication Unit 104 Arranged in Power Supply Device According to Present Embodiment

For example, the wireless communication unit 104 includes a high-frequency signal generating unit 150, a high-frequency transmitting unit 152, and a demodulating unit 154. For example, the wireless communication unit 104 transmits the high-frequency signal in response to the high-frequency signal generation command transferred from the control unit 106, and stops transmission of the high-frequency signal in response to the high-frequency signal transmission stop command transferred from the control unit 106.

The wireless communication unit 104 may include, for example, an encryption circuit (not shown) for encrypting communication, a communication anti-collision circuit, or a connection interface (not shown) for connecting an external device with another circuit. Here, for example, the structural elements of the wireless communication unit 104 are connected to each other via a bus serving as a transmission path of data. Examples of the connection interface include a Universal Asynchronous Receiver Transmitter (UART), a Local Area Network (LAN) terminal, and a transceiving circuit.

The high-frequency signal generating unit 150 receives the high-frequency signal generation command from the control unit 106, and the high-frequency signal corresponding to the high-frequency signal generation command. Here, in FIG. 4, AC power is used as the high-frequency signal generating unit 150, but the high-frequency signal according to the present embodiment generating unit 150 is not limited to this example. For example, the high-frequency signal according to the present embodiment generating unit 150 may include a modulating circuit (not shown) that performs Amplitude Shift Keying (ASK) modulation and an amplifying circuit (not shown) that amplifies an output of the modulating circuit.

Here, for example, a high-frequency signal including the identification information transmission request to request the external connection device to transmit the identification information or a high-frequency signal including various kinds of processing commands or data to process may be used as the high-frequency signal generated by the high-frequency signal generating unit 150. However, the high-frequency signal generated by the high-frequency signal generating unit 150 is not limited to this example. For example, the high-frequency signal according to the present embodiment may be a signal (for example, a non-modulated signal) causing the power line communication unit 208 of the power receiving device 200A to perform power supply.

For example, the high-frequency transmitting unit 152 includes a coil (inductor) L1 having a predetermined inductance, and transmits the carrier wave corresponding to the high-frequency signal generated by the high-frequency signal generating unit 150. Further, the high-frequency transmitting unit 152 can receive the response signal from the external connection device. In other words, the high-frequency transmitting unit 152 can function as a communication antenna of the wireless communication unit 104. Here, FIG. 4 illustrates the example in which the high-frequency transmitting unit 152 is constituted by the coil L1, but the configuration of the high-frequency transmitting unit 152 according to the present embodiment is not limited to this example. For example, the high-frequency transmitting unit according to the present embodiment may further include a capacitor to configure a resonance circuit.

For example, the demodulating unit 154 demodulates the response signal from the external connection device by performing envelope detection on a change in amplitude of a voltage in an antenna end of the high-frequency transmitting unit 152 and binarizing the detected signal. The demodulating device of the response signal in the demodulating unit 154 is not limited to the above example, and, for example, the demodulating unit 154 can demodulate the response signal using a change in a phase of a voltage in the antenna end of the high-frequency transmitting unit 152.

Further, the demodulating unit 154 transfers the demodulated response signal to the control unit 106. Then, when the demodulated response signal is transmitted to the control unit 106, for example, the control unit 106 performs a variety of processing as processing of processing data corresponding to the response signal and processing of generating the high-frequency signal generation command based on the processing result.

For example, through the configuration illustrated in FIG. 4, the wireless communication unit 104 transmits the carrier wave, and demodulates the response signal transmitted from the external connection device such as the power receiving device 200A. Of course, the configuration of the wireless communication unit 104 according to the present embodiment is not limited to the configuration illustrated in FIG. 4.

1-2. Wireless Communication Unit 204 Arranged in Power Receiving Device According to Present Embodiment

The wireless communication unit 204 includes a communication antenna 250 and an IC chip 252. For example, the structural elements of the wireless communication unit 204 are connected to each other via a bus 272 serving as a data transmission path.

The communication antenna 250 receives the carrier wave transmitted from the external connection device such as the power supply device 100A, and transmits the response signal based on a processing result of processing in the IC chip 252.

For example, the communication antenna 250 is constituted by a resonance circuit including a coil (inductor) L2 having a predetermined inductance and a capacitor C1 having a predetermined capacitance, and generates an inductive voltage by electromagnetic induction upon receiving the carrier wave. Then, the communication antenna 250 outputs a reception voltage obtained by resonating the inductive voltage at a predetermined resonance frequency. Here, for example, the resonance frequency in the communication antenna 250 is set according to the frequency of the carrier wave such as 13.56 [MHz]. Through the above-described configuration, the communication antenna 250 receives the carrier wave, and transmits the response signal by load modulation performed in a load modulating unit 264 (which will be described later) arranged in the IC chip 252.

The IC chip 252 demodulates and processes the high-frequency signal based on the received carrier wave, and transmits the response signal through the communication antenna 250 by the load modulation. In other words, the IC chip 252 functions substantially as a wireless communication unit that actively performs wireless communication in the wireless communication unit 204.

For example, the IC chip 252 includes a carrier detecting unit 254, a detecting unit 256, a regulator 258, a demodulating unit 260, a data processing unit 262, a load modulating unit 264, a Read Only Memory (ROM) 266, a Random Access Memory (RAM) 268, and an internal memory 270. The data processing unit 262, the ROM 266, the RAM 268, and the internal memory 270 are connected to one another, for example, via the bus 272 serving as a data transmission path. Although not shown in FIG. 4, for example, the IC chip 252 may further include a protection circuit (not shown) for preventing an overvoltage or an overcurrent from being applied to the data processing unit 262. Here, for example, a clamp circuit constituted by a diode and the like may be used as the protection circuit (not shown).

The carrier detecting unit 254 generates a detection signal of a rectangular shape based on the reception voltage transferred from the communication antenna 250, and transfers the detection signal to the data processing unit 262. For example, the data processing unit 262 uses the transferred detection signal as a processing clock for data processing. Here, the detection signal is based on the reception voltage transferred from the communication antenna 250 and thus synchronized with the frequency of the carrier wave transmitted from the external connection device. Thus, the IC chip 252 includes the carrier detecting unit 254 and thus can perform processing with the external connection device in synchronization with the external connection device.

The detecting unit 256 rectifies the reception voltage output from the communication antenna 250. Here, for example, the detecting unit 256 includes a diode D1 and a capacitor C2.

The regulator 258 converts the reception voltage into a constant voltage through smoothing, and outputs a driving voltage to the data processing unit 262. Here, for example, the regulator 258 uses a DC component of the reception voltage as the driving voltage.

The demodulating unit 260 demodulates the high-frequency signal based on the reception voltage, and outputs data (for example, a binary data signal having a high level and a low level) corresponding to the high-frequency signal included in the carrier wave. Here, for example, the demodulating unit 260 outputs an AC component of the reception voltage as data.

For example, the data processing unit 262 is driven using the driving voltage output from the regulator 258 as a power source, and processes data demodulated in the demodulating unit 260. Here, for example, the data processing unit 262 is constituted by an MPU, various processing circuits, or the like.

Further, the data processing unit 262 selectively generates a control signal used to control the load modulation related to the response to the external connection device according to the processing result. Then, the data processing unit 262 selectively outputs the control signal to the load modulating unit 264.

Further, for example, the data processing unit 262 reads data stored in the internal memory 270 based on a command included in the data demodulated in the demodulating unit 260 and updates the read data.

For example, the load modulating unit 264 includes a load Z and a switch SW1, and performs the load modulation by selectively connecting (validates) the load Z in response to the control signal transferred from the data processing unit 262. Here, for example, the load Z is constituted by a resistor having a predetermined resistance value, but the load Z is not limited to this example. For example, the switch SW1 is constituted by a p-channel type Metal Oxide Semiconductor Field effect transistor (MOSFET) or an n-channel type MOSFET, but the switch SW1 is not limited to this example.

The ROM 266 stores a program and control data such as a calculation parameter, which are used by the data processing unit 262. The RAM 268 temporarily stores a program executed by the data processing unit 262, a calculation result, an execution state, and the like.

The internal memory 270 is a storage unit arranged in the IC chip 252. For example, the internal memory 270 has a tamper resistance characteristic, and performs reading of data, new writing of data, updating of data, or the like through the data processing unit 262. For example, the internal memory 270 stores a variety of data such as identification information, an electronic value (currency or data having a value equivalent to currency), and an application. Here, FIG. 4 illustrates the example in which the internal memory 270 stores identification information 274 and an electronic value 276, but data stored in the internal memory 270 is not limited to this example.

For example, through the above-described configuration illustrated in FIG. 4, the IC chip 252 processes the high-frequency signal received through the communication antenna 250, and transmits the response signal from the communication antenna 250 through the load modulation.

For example, the wireless communication unit 204 includes the communication antenna 250 and the IC chip 252, and thus processes the high-frequency signal transmitted from the external connection device such as the power supply device 100A and transmits the response signal through the load modulation. Further, the configuration of the wireless communication unit 204 according to the present embodiment is not limited to the configuration illustrated in FIG. 4. For example, in the wireless communication unit 204, the structural elements configuring the IC chip 252 illustrated in FIG. 4 may not be configured in the form of an IC chip.

For example, when the wireless communication unit 104 illustrated in FIG. 4 is arranged in the power supply device according to the present embodiment, and the wireless communication unit 204 illustrated in FIG. 4 is arranged in the power receiving device according to the present embodiment, the power supply device according to the present embodiment and the power receiving device according to the present embodiment can perform wireless communication using the wireless communication technique such as the communication technique by NFC.

Here, by performing the wireless communication technique such as the communication technique by NFC or the wireless communication by the RFID technique, the power receiving device according to the present embodiment can be driven by power obtained from the received high-frequency signal and can transmit stored information by performing the load modulation. In other words, in the communication system including the power supply device according to the present embodiment and the power receiving device according to the present embodiment, the power receiving device according to the present embodiment can perform wireless communication even when a separate power supply circuit to perform communication is not arranged. Further, for example, the power receiving device according to the present embodiment can transmit stored information by performing the load modulation even when a signal (a signal representing the user's instruction) according to the user's operation is not input.

2. Power Line Communication of Present Embodiment

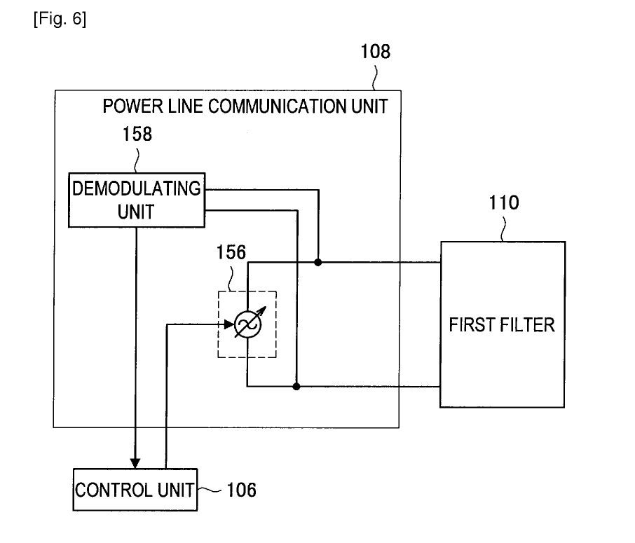

Next, the power line communication of the present embodiment will be described. FIG. 5 is an explanatory diagram for describing an example of the power line communication of the present embodiment. In the following, the power line communication of the present embodiment will be described using a power supply device 100B and a power receiving device 200B illustrated in FIG. 5 as an example. FIG. 5 illustrates structural elements related to the power line communication of the present embodiment in the configuration of the power supply device according to the present embodiment and the configuration of the power receiving device according to the present embodiment. In the power receiving device according to the present embodiment, for example, the structural elements related to the power line communication may be disposed in a plug as in the power receiving device 200A illustrated in FIG. 3.

2-1. Power Supply Device 100B

For example, the power supply device 100B includes a connecting unit 102, a control unit 106, a power line communication unit 108, a first filter 110 (a communication filter), and a second filter 112.

For example, the power supply device 100B may further include a ROM (not shown), a RAM (not shown), a storage unit (not shown), a display unit (not shown), and the like. For example, the structural elements of the power supply device 100B are connected to one another via a bus serving as a data transmission path. Here, the ROM (not shown) stores a program or control data such as a calculation parameter, which is used by the control unit 106. The RAM (not shown) temporarily stores a program executed by the control unit 106 or the like.

The storage unit (not shown) stores a variety of data including identification information acquired from the external connection device such as the power receiving device 200B, an application, and the like. Here, a magnetic recording medium such as a hard disk or a non-volatile memory such as an Electrically Erasable and Programmable Read Only Memory (EEPROM), a flash memory, a Magnetoresistive Random Access Memory (MRAM), a Ferroelectric Random Access Memory (FeRAM), and a Phase change Random Access Memory (PRAM) may be used as the storage unit (not shown). Further, the storage unit (not shown) may be removably mounted in the power supply device 100B.

The display unit (not shown) is a display device arranged in the power supply device 100B, and displays various information (for example, an image, text, and/or the like) on a display screen. For example, an operation screen through which a desired operation is performed on the power supply device 100B may be used as the screen displayed on the display screen of the display unit (not shown). Further, the display unit (not shown) may function as the notifying unit (which will be described later).

Here, a display device such as a Liquid Crystal Display (LCD) or an organic EL display (an organic ElectroLuminescence display device or an Organic Light Emitting Diode display) may be used as the display unit (not shown). For example, in the power supply device 100B, the display unit (not shown) may be constituted by a touch screen. In this case, the display unit (not shown) can function as an operation display unit in which both the user operation and a display can be performed.

In addition, the power supply device 100B can perform communication with an external terminal via a network (or directly) regardless of the installation the display unit (not shown) and cause the operation screen or various information to be displayed on a display screen of an external terminal. For example, when the external terminal is the external terminal (for example, a portable communication device or a remote controller) possessed by the user of the power supply device 100B, the user can operate his/her external terminal and cause the power supply device 100B to perform desired processing, and can check information transmitted from the power supply device 100B using the external terminal. Thus, in this case, for example, when the power supply device 100B is installed below a desk and it is not easy for the user to directly operate the power supply device 100B or to see information displayed on the display unit (not shown), the user's convenience can be improved.

The control unit 106 is constituted by an MPU or an IC circuit in which various kinds of circuits are integrated, and controls the components of the power supply device 100B. More specifically, for example, the control unit 106 controls the communication in the power line communication unit 108 by transferring the high-frequency signal generation command or the high-frequency signal transmission stop command to the power line communication unit 108 based on the detection signal transferred from the connecting unit 102 or the response signal of the external connection device such as the power receiving device 200B transferred from the power line communication unit 108. Here, as the control unit 106 transfers the high-frequency signal generation command or the high-frequency signal transmission stop command to the power line communication unit 108 based on the detection signal, communication with the external connection device which is the external device connected via the power line can be actually performed.

As the control unit 106 transfers the high-frequency signal generation command or the high-frequency signal transmission stop command to the power line communication unit 108 as described above, for example, the power line communication unit 108 can transmit the high-frequency signal based on the detection result in the connecting unit 102. Further, as the control unit 106 transfers the high-frequency signal generation command or the high-frequency signal transmission stop command to the power line communication unit 108 based on the response signal, it is possible to control communication with the external connection device such as the power receiving device 200B, which is performed via the power line. In addition, for example, as the control unit 106 transfers the high-frequency signal generation command to the power line communication unit 108 at regular intervals or irregular intervals, it is possible to cause the power line communication unit 108 to transmit the high-frequency signal at regular intervals or irregular intervals.

Further, the control unit 106 actively performs the process related to the notice control method according to the present embodiment (for example, the process (1) (the determination process) to the process (3) (the notice control process)) as described above. In the control unit 106 arranged in the power supply device according to the present embodiment, an example of a configuration to implement the process related to the notice control method according to the present embodiment will be described later.

The power line communication unit 108 undertakes communication with the external connection device such as the power receiving device 200B via the power line.

FIG. 6 is an explanatory diagram illustrating an example of a configuration of the power line communication unit 108 arranged in the power supply device 100B according to the present embodiment. Here, in FIG. 6, the control unit 106 and the first filter 110 are illustrated together. For example, the power line communication unit 108 includes a high-frequency signal generating unit 156 and a demodulating unit 158, and functions as a reader/writer (or an interrogator) in the NFC or the like. For example, the power line communication unit 108 may further include an encryption circuit (not shown) or a communication anti-collision circuit.

For example, upon receiving the high-frequency signal generation command transferred from the control unit 106, the high-frequency signal generating unit 156 generates the high-frequency signal corresponding to the high-frequency signal generation command. Further, upon receiving the high-frequency signal transmission stop command that is transferred from the control unit 106 and represents the transmission stop of the high-frequency signal, the high-frequency signal generating unit 156 stops the generation of the high-frequency signal. Here, in FIG. 6, AC power is illustrated as the high-frequency signal generating unit 156, but the high-frequency signal generating unit 156 according to the present embodiment is not limited to this example. For example, the high-frequency signal according to the present embodiment generating unit 132 may include a modulating circuit (not shown) that performs ASK modulation and an amplifying circuit (not shown) that amplifies an output of the modulating circuit.

Here, for example, the high-frequency signal including the identification information transmission request to request the external connection device to transmit the identification information or the high-frequency signal including various kinds of processing commands on the external connection device or data to process may be used as the high-frequency signal generated by the high-frequency signal generating unit 156. However, the high-frequency signal generated by the high-frequency signal generating unit 156 is not limited to this example. For example, the high-frequency signal according to the present embodiment may be a signal (for example, a non-modulated signal) causing the power line communication unit 208 of the power receiving device 200B to perform power supply.

For example, the demodulating unit 158 demodulates the response signal from the external connection device by performing envelope detection on a change in amplitude of a voltage between the high-frequency signal generating unit 156 and the first filter 110 and binarizing the detected signal. Then, the demodulating unit 158 transfers the demodulated response signal (for example, the response signal representing the identification information or the response signal representing the response based on processing corresponding to the high-frequency signal) to the control unit 106. The demodulating device of the response signal in the demodulating unit 158 is not limited to the above example, and, for example, the demodulating unit 158 can demodulate the response signal using a change in a phase of a voltage between the high-frequency signal generating unit 156 and the first filter 110.

For example, through the configuration illustrated in FIG. 6, the power line communication unit 108 of the present embodiment can function as the reader/writer in the NFC or the like and perform communication with the external connection device via the power line.

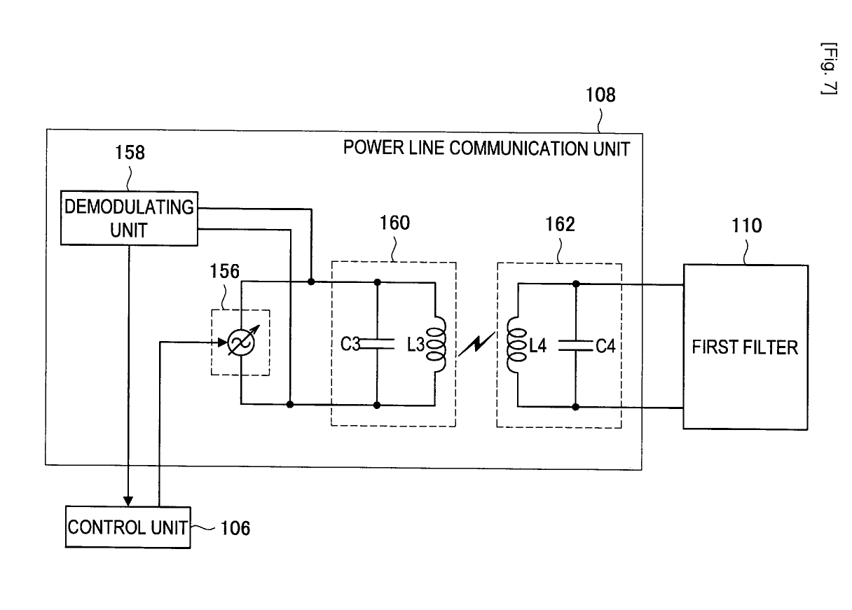

The configuration of the power line communication unit 108 of the present embodiment is not limited to the configuration illustrated in FIG. 6. FIG. 7 is an explanatory diagram illustrating another example of the power line communication unit 108 arranged in the power supply device 100B according to the present embodiment. Here, in FIG. 7, the control unit 106 and the first filter 110 are illustrated together, similarly to FIG. 6.

The power line communication unit 108 related to another example includes a highfrequency signal generating unit 156, a demodulating unit 158, a first high-frequency transceiving unit 160, and a second high-frequency transceiving unit 162. For example, the power line communication unit 108 related to another example may further include an encryption circuit (not shown) or a communication anti-collision circuit.

The high-frequency signal generating unit 156 generates the high-frequency signal in response to the high-frequency signal generation command, and stops the generation of the high-frequency signal in response to the high-frequency signal transmission stop command, similarly to the high-frequency signal generating unit 156 illustrated in FIG. 6.

The demodulating unit 158 demodulates the response signal from the external connection device by performing envelope detection on a change in amplitude of a voltage in an antenna end of the high-frequency signal generating unit 156 and binarizing the detected signal. The demodulating device of the response signal in the demodulating unit 158 is not limited to the above example, and, for example, the demodulating unit 158 can demodulate the response signal using a change in a phase of a voltage in the antenna end of the high-frequency signal generating unit 156.

For example, the first high-frequency transceiving unit 160 includes a coil (inductor; the same applies hereinafter) L3 having a predetermined inductance and a capacitor C3 having a predetermined capacitance and so configures a resonance circuit. Here, for example, the frequency of the high-frequency signal such as 13.56 [MHz] may be used as the resonance frequency of the first high-frequency transceiving unit 160. Through the above-described configuration, the first high-frequency transceiving unit 160 can transmit the high-frequency signal generated by the high-frequency signal generating unit 156, and receive the response signal transmitted from the external connection device through the second high-frequency transceiving unit 162. In other words, the first high-frequency transceiving unit 160 functions as a first communication antenna in the power line communication unit 108.

For example, the second high-frequency transceiving unit 162 includes a coil L4 having a predetermined inductance and a capacitor C4 having a predetermined capacitance and so configures a resonance circuit. Here, for example, the frequency of the high-frequency signal such as 13.56 [MHz] may be used as the resonance frequency of the second high-frequency transceiving unit 162. Through the above-described configuration, the second high-frequency transceiving unit 162 can receive the high-frequency signal transmitted from the first high-frequency transceiving unit 160 and transmit the response signal transmitted from the external connection device. In other words, the second high-frequency transceiving unit 162 functions as a second communication antenna in the power line communication unit 108.

Through the configuration illustrated in FIG. 7, the power line communication unit 108 of the present embodiment can function as the reader/writer in NFC and perform communication with the external connection device via the power line, similarly to the configuration illustrated in FIG. 6.

In the power supply device 100B according to the present embodiment, an example of a configuration related to the power line communication of the present embodiment will be described with reference to FIG. 5 again. The first filter 110 is connected between the power line communication unit 108 and the power line PL, and functions to filter a signal transferred from the power line PL. More specifically, the first filter 110 has a function of blocking at least a signal of a frequency of power supplied from the external connection device such as the power receiving device 200B via the power among signals transferred from the power line PL but passing the high-frequency signal. The power supply device 100B includes the first filter 110 and thus does not transfer a signal of a frequency of power that may cause noise to the power line communication unit 108. Thus, it is possible to improve the accuracy of communication between the power line communication unit 108 and the external connection device (more technically, for example, a power line communication unit arranged in the external connection device such as the power line communication unit 208 of the power receiving device 200B, which will be described later).

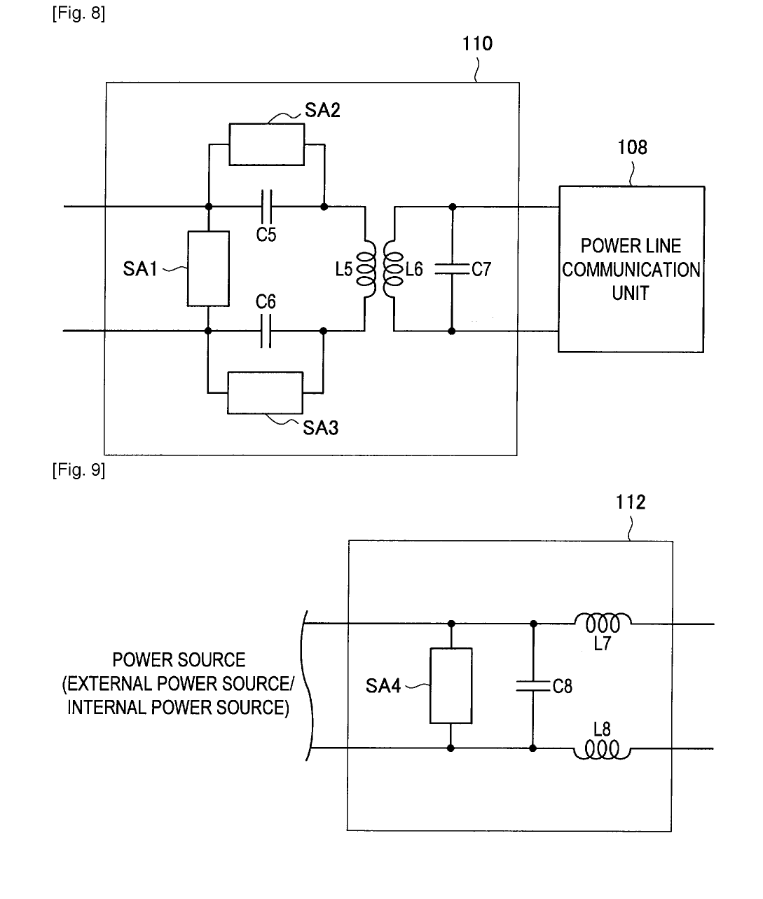

FIG. 8 is an explanatory diagram illustrating an example of a configuration of the first filter 110 arranged in the power supply device 100B according to the present embodiment. The first filter 110 includes inductors L5 and L6, capacitors C5 to C7 and surge absorbers SA1 to SA3. Of course, the configuration of the first filter 110 according to the present embodiment is not limited to the configuration illustrated in FIG. 8.

In the power supply device 100B according to the present embodiment, an example of a configuration of the power line communication of the present embodiment will be described with reference to FIG. 5 again. The second filter 112 is disposed on the power line PL between the connecting unit 102 and the power, and functions to perform filtering on a signal transferred from the connecting unit 102 side. Here, for example, an external power source such as a commercial power source or an internal power source such as a battery may be used as a power source according to the present embodiment.

More specifically, the second filter 112 has a function of blocking at least the highfrequency signal transmitted by the power line communication unit 108 or the highfrequency signal transmitted by the external connection device but passing a signal of a frequency of power supplied to the external connection device. The power supply device 100B includes the second filter 112 and thus can block, for example, the highfrequency signal related to the communication via the power line or a noise component such as a noise component transferred from the external connection device side. In other words, the second filter 112 functions as a so-called power splitter.

FIG. 9 is an explanatory diagram illustrating an example of a configuration of the second filter 112 arranged in the power supply device 100B according to the present embodiment. The second filter 112 includes inductors L7 and L8, a capacitor C8, and a surge absorber SA4. Of course, the configuration of the second filter 112 according to the present embodiment is not limited to the configuration illustrated in FIG. 9.

For example, through the configuration illustrated in FIG. 5, the power supply device 100B according to the present embodiment can perform communication with the external connection device such as the power receiving device 200B connected to the connecting unit 102 via the power line. Further, for example, through the configuration illustrated in FIG. 5, the power supply device 100B according to the present embodiment can cause the external connection device to perform a predetermined process based on the transmitted high-frequency signal such as transmission of the identification information and an accounting process using an electronic value.

2-2. Power Receiving Device 200B

For example, the power receiving device 200B includes a connecting unit 202, a first filter 206 (a communication filter), a power line communication unit 208, and a second filter 210.

For example, the power receiving device 200B includes a battery (not shown) and various kinds of devices (for example, an MPU, various kinds of processing circuits, and a driving device (not shown)) for implementing the function of the power receiving device 200B, which are arranged at the stage subsequent to the second filter 210 (on the side of the second filter 210 illustrated in FIG. 5 opposite to the power supply device 100B). In other words, for example, the power receiving device 200B can cause the battery (not shown) to be charged by power supplied from the external connection device such as the power supply device 100B via the power line and can implement the function of the power receiving device 200B using the supplied power. For example, when the power receiving device 200B is a vehicle such as an electric vehicle, the power receiving device 200B is supplied with power to charge an internal battery and rotates a vehicle using power from the battery. Further, when the power receiving device 200B includes a display device capable of displaying an image (a moving image/a still image) and/or text, the power receiving device 200B is supplied with power and causes an image or text to be displayed on the display screen of the display device. In addition, the display device may function as a notifying unit (which will be described later) in the power receiving device according to the present embodiment.

The first filter 206 is connected between the power line (technically, the power line PL in the power receiving device 200B) and the power line communication unit 208, and functions to perform filtering on a signal transferred from the power line. More specifically, the first filter 206 has a function of blocking at least a signal of a frequency of power among signals transferred from the power line but passing the high-frequency signal. The power receiving device 200B includes the first filter 206 and thus does not transfer a signal of a frequency of power that causes a noise to the power line communication unit 208. Thus, it is possible to improve the accuracy of communication between the power line communication unit 208 and the external connection device (more technically, for example, the power line communication unit arranged in the external connection device such as the power line communication unit 108 of the power supply device 100B.

Here, for example, the first filter 206 has the same configuration as the first filter 110 of the power supply device 100B illustrated in FIG. 8. Of course, the configuration of the first filter 206 according to the present embodiment is not limited to the configuration illustrated in FIG. 8.

The power line communication unit 208 performs communication with the external connection device such as the power supply device 100B via the power line based on the high-frequency signal. More specifically, for example, when the power line communication unit 208 receives the high-frequency signal from the external connection device, the power line communication unit 208 is driven by power obtained from the high-frequency signal and performs processing based on the received high-frequency signal. Then, the power line communication unit 208 transmits the response signal according to the above processing as the high-frequency signal through the load modulation.

For example, when the power line communication unit 208 receives the highfrequency signal including an identification information transmission request to request transmission of the identification information, the power line communication unit 208 reads the stored identification information based on the identification information transmission request included in the high-frequency signal. Then, the power line communication unit 208 performs transmission such that the read identification information is superimposed on the power line through the load modulation. For example, when the power line communication unit 208 receives the high-frequency signal including various kinds of processing commands or data to process, the power line communication unit 208 performs processing based on the processing command or the data included in the high-frequency signal. Then, the power line communication unit 208 performs transmission such that the response signal based on the above processing is superimposed on the power line through the load modulation. In other words, for example, the power line communication unit 208 functions as a responder in the NFC.

Further, the power line communication unit 208 functions to actively perform the process related to the notice control method according to the present embodiment (for example, the process (I) (the communication process) and the process (II) (the notice control process)). More specifically, the power line communication unit 208 performs the load modulation and performs communication with the external connection device such as the power supply device 100B as described above (which corresponds to the process (I) (the communication process)). Further, for example, the power line communication unit 208 causes the notifying unit (which will be described later) arranged in the power receiving device according to the present embodiment and/or external device to perform the notice based on the communication result related to the authentication (which corresponds to the process (II) (the notice control process)) based on the communication result (the communication result related to the authentication in the process (I) (the communication process)) related to the authentication with the external connection device.

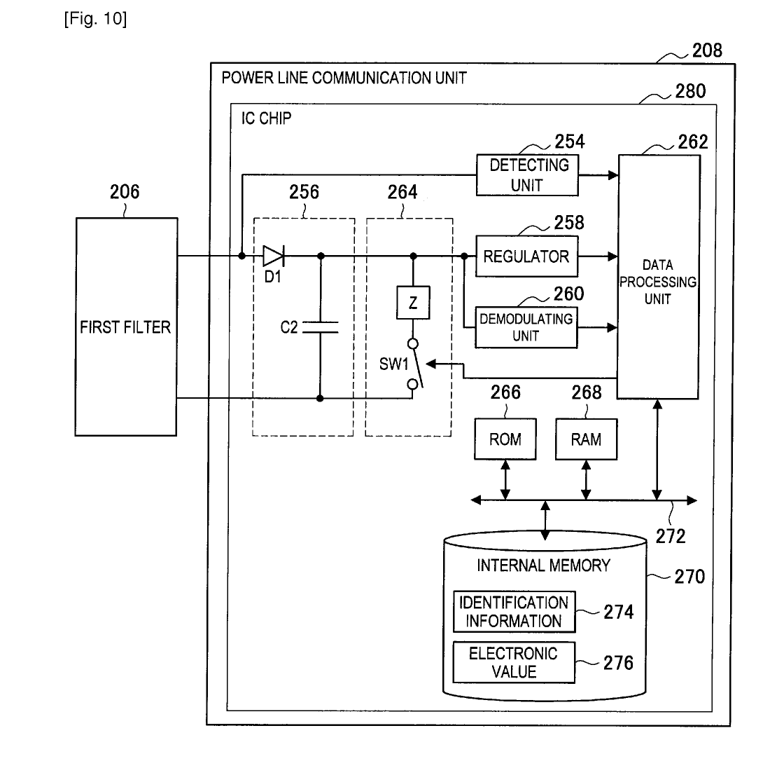

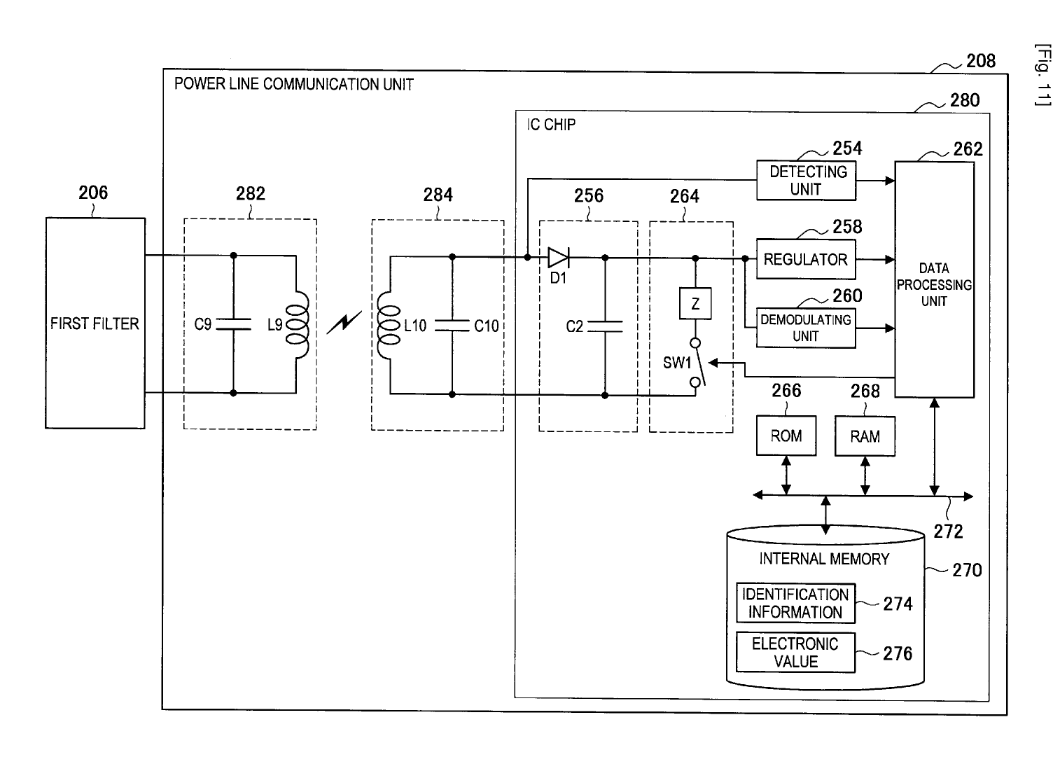

FIG. 10 is an explanatory diagram illustrating an example of a configuration of the power line communication unit 208 arranged in the power receiving device 200B according to the present embodiment. Here, FIG. 10 illustrates this together with the first filter 206. Further, FIG. 10 illustrates a configuration in which the power line communication unit 208 includes an IC chip 280 that demodulates and processes the received high-frequency signal and transmits the response signal through the load modulation. In the power line communication unit 208 of the present embodiment, each of structural elements configuring the IC chip 280 illustrated in FIG. 10 may not be configured in the form of an IC chip.

For example, the IC chip 280 includes a detecting unit 254, a detecting unit 256, a regulator 258, a demodulating unit 260, a data processing unit 262, and a load modulating unit 264. Although not shown in FIG. 10, for example, the IC chip 280 may further include a protection circuit (not shown) for preventing an overvoltage or an overcurrent from being applied to the data processing unit 262. Here, for example, a clamp circuit constituted by a diode or the like may be used as the protection circuit (not shown).

For example, the IC chip 280 includes a ROM 234, a RAM 236, and an internal memory 238. For example, the data processing unit 262, the ROM 234, the RAM 236, and the internal memory 238 are connected to one another via a bus 240 serving as a data transmission path.

Here, when the configuration of the IC chip 280 illustrated in FIG. 10 is compared with the configuration of the IC chip 252 arranged in the wireless communication unit 204 illustrated in FIG. 4 which relates to the wireless communication according to the present embodiment, it can be understood that the IC chip 280 has the same configuration as the IC chip 252 illustrated in FIG. 4.

As described above, the high-frequency signal based on the received carrier wave is input to the IC chip 252 illustrated in FIG. 4 through the communication antenna 250, and the IC chip 252 modulates and processes the high-frequency signal based on the carrier wave received by the communication antenna 250, and transmits the response signal to the communication antenna 250 through the load modulation. On the other hand, the high-frequency signal transmitted from the external connection device such as the power supply device 100B, which is transferred from the first filter 206, is input to the IC chip 280. Further, the IC chip 280 has the same configuration as the IC chip 252 illustrated in FIG. 4 as illustrated in FIG. 10. Thus, the IC chip 280 can demodulate and process the input high-frequency signal and transmit the response signal corresponding to the high-frequency signal through the load modulation, similarly to the IC chip 252 illustrated in FIG. 4.

Further, the IC chip 280 is connected to the first filter 206 as illustrated in FIG. 10, and the first filter 206 is connected to the power line PL as illustrated in FIG. 5. Thus, the response signal transmitted from the IC chip 280 is superimposed on the power line through the first filter 206.

For example, through the configuration illustrated in FIG. 10, the IC chip 280 processes the received high-frequency signal, and performs transmission such that the processed signal is superimposed on the response signal through the load modulation. Of course, the configuration of the IC chip 280 according to the present embodiment is not limited to the configuration illustrated in FIG. 10.

For example, through the configuration illustrated in FIG. 10, the power line communication unit 208 can be driven by power obtained from the received high-frequency signal, perform processing represented by the received high-frequency signal, and transmit the response signal according to the processing through the load modulation.

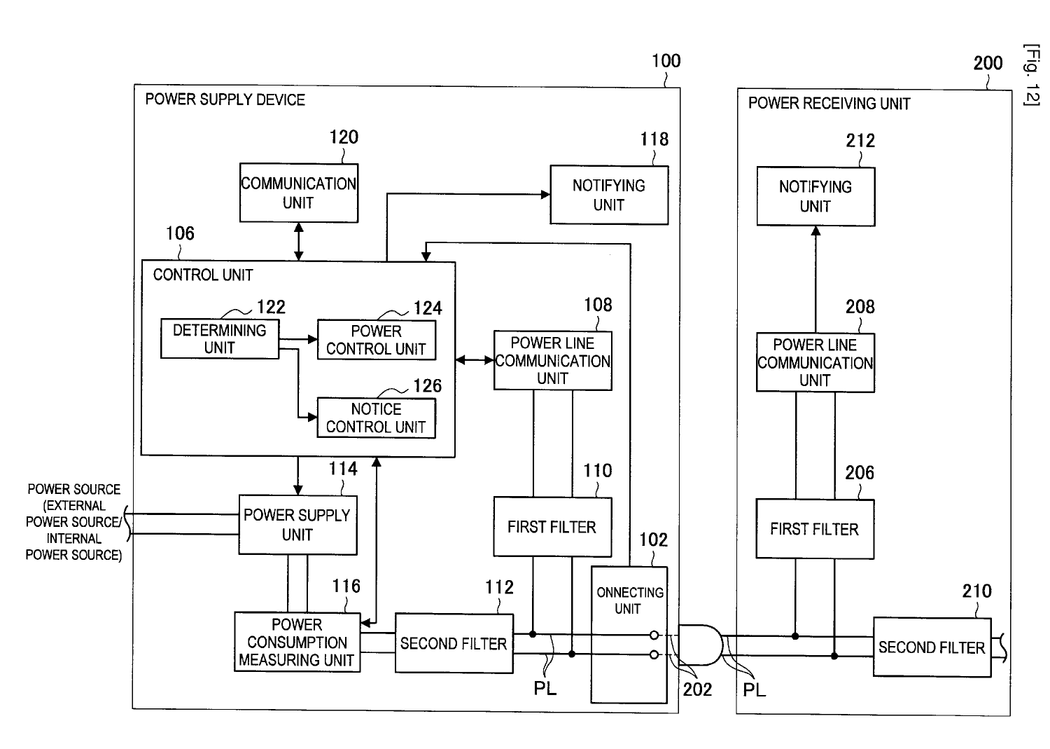

The power line communication unit 208 of the present embodiment is not limited to the configuration illustrated in FIG. 10. FIG. 11 is an explanatory diagram illustrating another example of the configuration of the power line communication unit 208 arranged in the power receiving device 200B according to the present embodiment. Here, FIG. 11 illustrates this together with the first filter 206. In the power line communication unit 208 of the present embodiment, each of structural elements configuring the IC chip 280 illustrated in FIG. 11 may not be configured in the form of an IC chip.

The power line communication unit 208 according to another example includes a first high-frequency transceiving unit 282, a second high-frequency transceiving unit 284, and an IC chip 280.

For example, the first high-frequency transceiving unit 282 includes a coil L9 having a predetermined inductance and a capacitor C9 having a predetermined capacitance and so configures a resonance circuit. Here, for example, the frequency of the highfrequency signal such as 13.56 [MHz] may be used as the resonance frequency of the first high-frequency transceiving unit 282. Through the above-described configuration, the first high-frequency transceiving unit 282 can transmit the high-frequency signal transferred from the first filter 206, and receive the response signal transmitted from the second high-frequency transceiving unit 284. In other words, the first highfrequency transceiving unit 282 functions as a first communication antenna in the power line communication unit 208.

For example, the second high-frequency transceiving unit 284 includes a coil L10 having a predetermined inductance and a capacitor C10 having a predetermined capacitance and so configures a resonance circuit. Here, for example, the frequency of the high-frequency signal such as 13.56 [MHz] may be used as the resonance frequency of the second high-frequency transceiving unit 284. Through the above-described configuration, the second high-frequency transceiving unit 284 can receive the high-frequency signal transmitted from the first high-frequency transceiving unit 282 and transmit the response signal. More specifically, the second high-frequency transceiving unit 284 generates an inductive voltage through the electromagnetic induction upon receiving the high-frequency signal, and outputs a reception voltage obtained by resonating the inductive voltage at a predetermined resonance frequency to the IC chip 280. Further, the second high-frequency transceiving unit 284 transmits the response signal through the load modulation performed in the load modulating unit 264 arranged in the IC chip 280. In other words, the second high-frequency transceiving unit 284 functions as a second communication antenna in the power line communication unit 208.

The IC chip 280 performs the same processing as in the IC chip 280 illustrated in FIG. 10 based on the reception voltage transferred from the second high-frequency transceiving unit 284.

Even through the configuration illustrated in FIG. 11, the power line communication unit 208 can be driven by power obtained from the received high-frequency signal, perform processing represented by the received high-frequency signal, and transmit the response signal according to the processing through the load modulation, similarly to the configuration illustrated in FIG. 10. Further, when the power line communication unit 208 has the configuration illustrated in FIG. 11, the power line communication unit 208 can use an IC chip related to, for example, NFC or RFID, and thus there is an advantage in that implementation can be easily performed.

In the power receiving device 200B according to the present embodiment, an example of the configuration of the power line communication of the present embodiment will be described with reference to FIG. 5 again. The second filter 210 functions to perform filtering on a signal transferred from the external connection device side such as the power supply device 100B through the power line PL. More specifically, the second filter 210 has a function of blocking at least the high-frequency signal transmitted by the external connection device or the high-frequency signal transmitted by the power line communication unit 208 but passing a signal of a frequency of power supplied through the power line PL. The power receiving device 200B includes the second filter 210 and thus can block, for example, the highfrequency signal related to the communication via the power line or a noise component such as a noise component transferred from the external connection device side. In other words, the second filter 210 functions as a so-called power splitter, similarly to the second filter 112 arranged in the power supply device 100B.

Here, for example, the second filter 210 may have the same configuration as the second filter 112 of the power supply device 100B illustrated in FIG. 9. Of course, the configuration of the second filter 210 according to the present embodiment is not limited to the configuration illustrated in FIG. 9.

For example, as the power supply device according to the present embodiment includes the power line communication unit 108 illustrated in FIG. 5, and the power receiving device according to the present embodiment includes the power line communication unit 208 illustrated in FIG. 5, the power supply device according to the present embodiment and the power receiving device according to the present embodiment can perform power line communication in which the wireless communication technique such as the communication technique by NFC is applied to the wired communication.

Here, the communication device using the wireless communication technique such as the communication technique by NFC is much smaller in circuit size than an existing PLC modem, and thus the size of the communication device can be reduced to the same size as an IC chip. For example, with the spread of devices capable of performing communication using the wireless communication technique such as the communication technique by the NFC, for example, a portable telephone in which an IC card or an IC chip is mounted, the communication device using the wireless communication technique such as the communication technique by the NFC or RFID technique is cheaper than an existing PLC modem.

Further, as the wireless communication technique such as the communication technique by the NFC or RFID technique is applied to the wired communication, the power receiving device according to the present embodiment can be driven by power obtained from the received high-frequency signal through the power line and can transmit stored information by performing the load modulation. In other words, in the communication system including the power supply device according to the present embodiment and the power receiving device according to the present embodiment, the power receiving device according to the present embodiment can perform wired communication even when a separate power supply circuit to perform communication is not arranged. Further, for example, the power receiving device according to the present embodiment can transmit stored information by performing the load modulation even when a signal (a signal representing the user's instruction) according to the user's operation is not input.

Thus, when the wireless communication technique such as the communication technique by the NFC or the RFID technique is used, it is possible to implement wired communication in which a cost is low, a limitation on the size of a communication device is mitigated, and power consumption is low, more than, for example, when conventional wired communication such as an existing PLC is used.

(Power Supply Device and Power Receiving Device According to Present Embodiment)

Next, an example of configurations of the power supply device according to the present embodiment and the power receiving device according to the present embodiment, which are capable of performing the process related to the notice control method according to the present embodiment, will be described. Further, in the following, an example of configurations of the power supply device according to the present embodiment and the power receiving device according to the present embodiment will be described in connection with an example in which the power supply device according to the present embodiment performs communication with the power receiving device according to the present embodiment according to the power line communication of the present embodiment illustrated in FIG. 5.

FIG. 12 is an explanatory diagram illustrating an example of configurations of a power supply device 100 according to the present embodiment and a power receiving device 200 according to the present embodiment. Here, FIG. 12 illustrates an example in which the power supply device 100 and the power receiving device 200 have a configuration capable of implementing the power line communication of the present embodiment illustrated in FIG. 5.

1. Example of Configuration of Power Supply Device 100 According to Present Embodiment

For example, the power supply device 100 includes a connecting unit 102, a control unit 106, a power line communication unit 108, a first filter 110, a second filter 112, a power supply unit 114, a power consumption measuring unit 116, a notifying unit 118, and a communication unit 120.

The power supply device 100 may further include, for example, a ROM (not shown), a RAM (not shown), a storage unit (not shown), a display unit (not shown), and the like. For example, the structural elements of the power supply device 100 are connected to one another via a bus serving as a data transmission path.

For example, the control unit 106 is constituted by an MPU, various kinds of processing circuits, or the like, and functions to control the power supply device 100 in general. For example, the control unit 106 includes a determining unit 122, a power control unit 124, and a notice control unit 126, and functions to actively perform the process related to the notice control method according to the present embodiment.

The determining unit 122 functions to actively perform the process (1) (the determination process), and determines whether or not the external connection device is the external device of the power supply target. More specifically, for example, when the communication result with the external connection device and the identification information from the identification information are acquired, the determining unit 122 determines whether or not the external connection device is the external device of the power supply target based on the authentication result of the external connection device which is based on the identification information.

The determining unit 122 transfers a signal (an analog signal/a digital signal) representing the determination result to the power control unit 124 and the notice control unit 126.

The power control unit 124 functions to actively perform the process (2) (the power control process), and selectively transmit power to the external connection device based on the determination result transferred from the determining unit 122 when it is determined that the external connection device is the external device of the power supply target. More specifically, for example, the power control unit 124 selectively transmits power to the external connection device by transferring a control signal used to control selective supply of power to the power line PL in the power supply unit 114 to the power supply unit 114 and controlling an operation of the power supply unit 114.

For example, the power control unit 124 may control an operation of the power consumption measuring unit 116 by transferring a control signal used to control a start or stop of measurement of power consumption in the external connection device such as the power receiving device 200 in the power consumption measuring unit 116 to the power consumption measuring unit 116.

The notice control unit 126 functions to actively perform the process (3) (the notice control process), and cause a notice based on the determination result to be made based on the determination result transferred from the determining unit 122. More specifically, for example, the notice control unit 126 causes the notifying unit 118 to make a notice based on the determination result by transferring a control signal (or control data) used to control a notice to the notifying unit 118. For example, the notice control unit 126 causes the external device to make a notice based on the determination result by causing the communication unit 120 to transmit the control data used to control a notice to the external device that is to make a notice. Here, for example, the control signal or the control data used to control a notice according to the present embodiment includes a notice command used to cause a notice to be made. The control signal or the control data used to control a notice according to the present embodiment may further include, for example, data (for example, image data, audio data, or the like) representing notice content.

For example, the notice control unit 126 may cause both of the notifying unit 118 and the external device to make a notice or may cause either of the notifying unit 118 and the external device to make a notice.

For example, the control unit 106 includes, for example, the determining unit 122, the power control unit 124, and the notice control unit 126 and thus actively performs the process related to the notice control method according to the present embodiment in the power supply device according to the present embodiment.

The power line communication unit 108 functions as a communication unit that performs communication with the external connection device. For example, as described above with reference FIGS. 6 and 7, communication in the power line communication unit 108 is controlled by, for example, the control unit 106, and the power line communication unit 108 transfers the demodulated response signal to the control unit 106.

As described above with reference to FIG. 5 and the like, for example, as the power line communication unit 108 is provided, the power supply device 100 makes an attempt to perform communication with the external connection device via the power line and can acquire the identification information from the external connection device when the external connection device supports a predetermined authentication function. Thus, as the power line communication unit 108 is provided, the control unit 106 (more technically, the determining unit 122) can perform the process (1) (the determination process) based on the communication result in the power line communication unit 108.

For example, the power supply unit 114 selectively connects power (for example, an internal power source or an external power source) to the power line PL based on the control signal transferred from the control unit 106 (more technically, the power control unit 124), and selectively supplies the power line PL with power.

Here, for example, a switch which is turned on or off based on a control signal transferred from the control unit 106 may be used as the power supply unit 114. For example, the switch is constituted by a p-channel type MOSFET or an n-channel type MOSFET, but a configuration of the switch is not limited to this example.

The power consumption measuring unit 116 is connected to the connecting unit 102 and measures power consumption expended by the external connection device such as the power receiving device 200. The power consumption measuring unit 116 transfers information of measured power consumption to the control unit 106. For example, the power consumption measuring unit 116 can selectively perform measurement based on a control signal transferred from the control unit 106 (more technically, the power control unit 124). Here, for example, a power consumption meter may be used as the power consumption measuring unit 116.

The notifying unit 118 makes a notice based on the determination result in the determining unit 122. More specifically, the notifying unit 118 makes a notice based on a control signal (or control data) transferred from the notice control unit 126. In other words, the notice in the notifying unit 118 is controlled by the notice control unit 126.

Here, for example, a display device that functions as a display unit (not shown), a digital signal processor (DSP), or an audio output device may be used as the notifying unit 118. Further, for example, an amplifier or a speaker may be used as the audio output device according to the present embodiment.

For example, when the display device functions as the notifying unit 118, the power supply device 100 can notify the user of whether or not the external connection device (the external device connected using the power line) supports a predetermined authentication function through the visual notice method. For example, when the DSP or the audio output device functions as the notifying unit 118, the power supply device 100 can notify the user of whether or not the external connection device supports a predetermined authentication function through the acoustical notice method.

The notifying unit 118 according to the present embodiment is not limited to the display device, the DSP, and the audio output device. For example, the notifying unit 118 may be an arbitrary device for implementing a method of appealing to the user's senses. For example, the notifying unit 118 may include the display device, the DSP, and the audio output device, that is, may have a configuration capable of implementing a plurality of notifying methods.

The communication unit 120 is a communication unit arranged in the power supply device 100, and performs wired or wireless communication with an external device with a notifying function such as a display device or an audio output device or an external device such as a server via a network (or directly). For example, communication of the communication unit 120 is controlled by the control unit 106.

Here, when the communication unit 120 is provided, for example, the power supply device 100 can transmit control data used to control a notice to the external device. Thus, when the communication unit 120 is arranged, the power supply device 100 can cause the external device to notify the user of whether or not the external connection device (the external device connected using the power line) supports a predetermined authentication function.

Here, for example, a communication antenna and a radio frequency (RF) circuit (wireless communication), an IEEE802.15.1 port and a transceiving circuit (wireless communication), an IEEE802.11b port and a transceiving circuit (wireless communication), or a local area network (LAN) terminal and a transceiving circuit (wired communication) may be used as the communication unit 120. Further, the communication unit 120 may have a configuration conforming to an arbitrary communication standard such as a universal serial bus (USB) terminal and a transceiving circuit or a configuration capable of performing communication such as an external device via a network. Examples of the network according to the present embodiment includes a wired network such as a LAN or a wide area network (WAN), a wireless network such as a wireless LAN (WLAN) or a wireless WAN (WWAN) via a base station, and the Internet using a communication protocol such as a transmission control protocol/Internet protocol (TCP/IP).

For example, the power supply device 100 performs the process related to the notice control method according to the present embodiment (for example, the process (1) (the determination process) to the process (3) (the notice control process)) through the configuration illustrated in FIG. 12. Thus, for example, the power supply device 100 can notify the user of whether or not the external device (the external connection device) connected using a power line supports a predetermined authentication function through the configuration illustrated in FIG. 12.

The configuration of the power supply device according to the present embodiment is not limited to the configuration illustrated in FIG. 12. For example, the power supply device according to the present embodiment may individually include one or more of the determining unit 122, the power control unit 124, and the notice control unit 126 illustrated in FIG. 12 (for example, each unit may be implemented by an individual processing circuit).

Further, for example, the power supply device according to the present embodiment may have a configuration in which either of the notifying unit 118 and the communication unit 120 is not provided. Through the above-described configuration, the power supply device according to the present embodiment can cause either the notifying unit 118 or the external device to notify the user of whether or not the external device (the external connection device) connected using a power line supports a predetermined authentication function, for example, through the process (1) (the determination process) to the process (3) (the notice control process).

Further, for example, the power supply device according to the present embodiment may not include the power consumption measuring unit 116. Even through the above-described configuration, the power supply device according to the present embodiment can notify the user of whether or not the external device (the external connection device) connected using a power line supports a predetermined authentication function, for example, through the process (1) (the determination process) to the process (3) (the notice control process).

Further, for example, the power supply device according to the present embodiment may further include the power line communication of the power receiving device according to the present embodiment illustrated in FIGS. 10 and 11.

2. Example of Configuration of Power Receiving Device 200 According to Present Embodiment

For example, the power receiving device 200 includes a connecting unit 202, a first filter 206, a power line communication unit 208, a second filter 210, and a notifying unit 212. For example, the power receiving device 200 includes a battery (not shown), various kinds of devices (not shown) for implementing the function of the power receiving device 200, and the like, which are arranged at the stage subsequent to the second filter 210 (on the side of the second filter 210 illustrated in FIG. 12 opposite to the power supply device 100).

For example, the power line communication unit 208 functions as a communication unit that performs communication with the external connection device by performing load modulation based on the signal transmitted from the external connection device as described above with reference to FIGS. 10 and 11. Further, as described above, the power line communication unit 208 actively performs the process related to the notice control method according to the present embodiment (for example, the process (I) (the communication process) and the process (II) (the notice control process)). In other words, the power line communication unit 208 functions as the communication unit that performs the process (I) (the communication process) and the notice control unit that performs the process (II) (the notice control process).

More specifically, the power line communication unit 208 performs communication with the external connection device such as the power supply device 100B via the power line (which corresponds to the process (I) (the communication process)) by performing the load modulation.

Further, for example, the power line communication unit 208 causes the notifying unit 212 to make the notice based on the communication result related to the authentication (which corresponds to the process (II) (the notice control process)) by transferring the control signal (or control data) used to control the notice to the notifying unit 212 based on the communication result (the communication result related to authentication in the process (I) (the communication process)) related to authentication with the external connection device, similarly to the notice control unit 126 of the power supply device 100 illustrated in FIG. 12. Here, in the power line communication unit 208, for example, the data processing unit 262 illustrated in FIGS. 10 and 11 performs the process (II) (the notice control process).

Here, for example, when the high-frequency signal transmitted from the external connection device is received (for example, the external connection device supports a predetermined authentication function), the power line communication unit 208 performs the process (II) (the notice control process) using power obtained from the received high-frequency signal. Further, for example, when the high-frequency signal is not received (for example, the external connection device does not support a predetermined authentication function), for example, when the high-frequency signal is not transmitted from the external connection device, the power line communication unit 208 performs the process (II) (the notice control process) using power obtained from the power line PL or power obtained from the internal power source.

In addition, when the receiving device 200 includes the communication unit (not shown) that performs wired or wireless communication with the external device via a network (or directly), for example, the power line communication unit 208 may cause the external device to make the notice based on the communication result by causing the communication unit (not shown) to transmit control data used to control the notice to the external device that is to make the notice.

The notifying unit 212 makes the notice based on the communication result related to the authentication. More specifically, for example, the notifying unit 212 makes a notice based on a control signal (or control data) transferred from the power line communication unit 208. Further, for example, the notifying unit 212 is driven by power obtained from the high-frequency signal, power obtained from the power line PL, or power obtained from the internal power source such as a battery and makes a notice.

Here, for example, a display device that functions as a display unit (not shown), a DSP, or an audio output device may be used as the notifying unit 212. For example, when the display device functions as the notifying unit 212, the power receiving device 200 can notify the user of whether or not the external connection device (the external device connected using the power line) supports a predetermined authentication function through the visual notice method. For example, when the DSP or the audio output device functions as the notifying unit 212, the power receiving device 200 can notify the user of whether or not the external connection device supports a predetermined authentication function through the acoustical notice method.

The notifying unit 212 according to the present embodiment is not limited to the display device, the DSP, and the audio output device. For example, the notifying unit 212 may have an arbitrary device for implementing a method of appealing to the user's senses. For example, the notifying unit 218 may include the display device, the DSP, and the audio output device, that is, may have a configuration capable of implementing a plurality of notifying methods.

For example, through the configuration illustrated in FIG. 12, the power receiving device 200 performs the process related to the notice control method according to the present embodiment (for example, the process (I) (the communication process) and the process (II) (the notice control process)). Thus, for example, through the configuration illustrated in FIG. 12, the power receiving device 200 can notify the user of whether or not the external device (the external connection device) connected using a power line supports a predetermined authentication function.

Further, the configuration of the power receiving device according to the present embodiment is not limited to the configuration illustrated in FIG. 12. For example, the power receiving device according to the present embodiment may include a communication unit (not shown) that performs wired or wireless communication with the external device as described above. In the case of the above-described configuration, the power receiving device according to the present embodiment can cause the external device that performs wired or wireless communication to notify the user of whether or not the external device (the external connection device) connected using a power line supports a predetermined authentication function. Further, for example, when the communication unit (not shown) is provided, the power receiving device according to the present embodiment may have a configuration that does not include the notifying unit 212.

In addition, for example, the power receiving device according to the present embodiment may include a power supply unit (not shown) that selectively blocks power transmitted via the power line PL which is arranged at the stage subsequent to the second filter 210 (on the side of the second filter 210 illustrated in FIG. 12 opposite to the power supply device 100). For example, the power supply unit (not shown) selectively blocks power transmitted through the power line PL based on the control signal based on the communication result related to authentication in the process (I) (the communication process), which is transferred from the power line communication unit 208.

More specifically, for example, when the communication result representing that “the communication related to the authentication is performed” is not obtained in the process (I) (the communication process), the power line communication unit 208 transfers a control signal having a voltage level to block power transmitted through the power line PL to the power supply unit (not shown). Then, the power supply unit (not shown) blocks power transmitted through the power line PL based on the control signal transferred from the power line communication unit 208. Here, for example, a switch which is turned on or off based on a control signal transferred from the power line communication unit 208 may be used as the power supply unit (not shown). For example, the switch is constituted by a p-channel type MOSFET or an n-channel type MOSFET. Further, the power line communication unit 208 transfers the control signal having a voltage level corresponding to a conductive type of the MOSFET that configures the switch of the power supply unit (not shown).

Further, the power receiving device according to the present embodiment may further include the power line communication unit of the power supply device according to the present embodiment as illustrated in FIG. 4.

For example, the power supply device according to the present embodiment and the power receiving device according to the present embodiment may have the configuration illustrated in FIG. 12 (or the configuration according to the modified example of FIG. 12; the same applies hereinafter). In this case, the power supply device according to the present embodiment and the power receiving device according to the present embodiment can perform the process related to the notice control method according to the present embodiment. Thus, the power supply device according to the present embodiment and the power receiving device according to the present embodiment have, for example, the configuration illustrated in FIG. 12 and thus can notify the user of whether or not the external device (the external connection device) connected using a power line supports a predetermined authentication function.

The power supply device according to the present embodiment and the power receiving device according to the present embodiment have, for example, the configuration illustrated in FIG. 12 and thus can cause the user to recognize whether or not the external device (the external connection device) connected using a power line supports a predetermined authentication function. Thus, the power supply device according to the present embodiment and the power receiving device according to the present embodiment can improve the user's convenience, for example, through the configuration illustrated in FIG. 12.

3. Other Configuration Examples of Power Supply Device According to Present Embodiment and Power Receiving Device According to Present Embodiment

3-1. First Modified Example

The configurations of the power supply device according to the present embodiment and the power receiving device according to the present embodiment are not limited to the configuration illustrated in FIG. 12. For example, FIG. 12 illustrates the configuration in which the power supply device according to the present embodiment performs communication with the power receiving device according to the present embodiment through the power line communication of the present embodiment. The power supply device according to the present embodiment can perform communication with the power receiving device according to the present embodiment through wireless communication according to the present embodiment. More specifically, when communication is performed through wireless communication according to the present embodiment, for example, the power supply device according to the present embodiment and the power receiving device according to the present embodiment include a configuration in which communication is performed through the wireless communication according to the present embodiment illustrated in FIG. 5 instead of the configuration in which communication is performed through the power line communication according to the present embodiment illustrated in FIG. 3.

Here, even when the configuration in which communication is performed through wireless communication according to the present embodiment is provided, for example, the power supply device according to the first modified example of the present embodiment can perform the process (1) (the determination process) to the process (3) (the notice control process). Further, even when the configuration in which communication is performed through the wireless communication according to the present embodiment is provided, for example, the power receiving device according to the first modified example of the present embodiment can perform the process (I) (the communication process) and the process (II) (the notice control process).

Thus, even when the configuration in which communication is performed through the wireless communication according to the present embodiment is provided, for example, the power supply device according to the present embodiment and the power receiving device according to the present embodiment can notify the user of whether or not the external device (the external connection device) connected using a power line supports a predetermined authentication function, for example, similarly to the example in which the configuration illustrated in FIG. 12 is provided. In addition, even when the configuration in which communication is performed through the wireless communication according to the present embodiment is provided, the power supply device according to the present embodiment and the power receiving device according to the present embodiment can improve the user's convenience, for example, similarly to the example in which the configuration illustrated in FIG. 12 is provided.

3-2 Second Modified Example

For example, the power supply device according to the present embodiment and the power receiving device according to the present embodiment may have both the configuration in which communication is performed through the power line communication according to the present embodiment and the configuration in which communication is performed through the wireless communication according to the present embodiment. More specifically, for example, the power supply device according to the present embodiment and the power receiving device according to the present embodiment may have the configuration in which communication is performed through the wireless communication according to the present embodiment illustrated in FIG. 3 and the configuration in which communication is performed through the power line communication according to the present embodiment illustrated in FIG. 5.

Here, even when both the configuration in which communication is performed through the power line communication according to the present embodiment and the configuration in which communication is performed through the wireless communication according to the present embodiment are provided, for example, the power supply device according to the second modified example of the present embodiment can perform the process (1) (the determination process) to the process (3) (the notice control process). Further, even when both the configuration in which communication is performed through the power line communication according to the present embodiment and the configuration in which communication is performed through the wireless communication according to the present embodiment are provided, for example, the power receiving device according to the second modified example of the present embodiment can perform the process (I) (the communication process) and the process (II) (the notice control process).

Thus, even when both the configuration in which communication is performed through the power line communication according to the present embodiment and the configuration in which communication is performed through the wireless communication according to the present embodiment are provided, for example, the power supply device according to the present embodiment and the power receiving device according to the present embodiment can notify the user of whether or not the external device (the external connection device) connected using a power line supports a predetermined authentication function, similarly to the example in which the configuration illustrated in FIG. 12 is provided. In addition, even when both the configuration in which communication is performed through the power line communication according to the present embodiment and the configuration in which communication is performed through the wireless communication according to the present embodiment are provided, for example, the power supply device according to the present embodiment and the power receiving device according to the present embodiment can improve the user's convenience, similarly to the example in which the configuration illustrated in FIG. 12 is provided.

Furthermore, even when both the configuration in which communication is performed through the power line communication according to the present embodiment and the configuration in which communication is performed through the wireless communication according to the present embodiment are provided, the power supply device according to the present embodiment and the power receiving device according to the present embodiment may change a notifying method or notice content according to a path in which communication is performed.

Hereinbefore, the power supply device has been described as the present embodiment, but the present embodiment is not limited to this example. For example, the present embodiment can be applied to various machines or facilities such as electrical outlets installed in buildings or the like, devices that supply power to computers such as personal computers (PCs) or servers, multi-plugs, electric vehicles, power-driven devices, or the like, display devices, or the like. In addition, for example, the present embodiment can be applied to vehicles such as electric vehicles that undertake the function of the power supply device. Moreover, the power supply device according to the present embodiment may receive power transmitted from the external connection device. In other words, the power supply device according to the present embodiment may undertake the function of the power receiving device.

Further, the power receiving device has been described as the present embodiment, and the present embodiment is not limited to this example. For example, the present embodiment can be applied to various devices driven by electric power such as communication devices such as computers such as PC, mobile phones, or smart phones, video/audio reproducing devices (or video/audio recording/reproducing devices), portable game machines, display devices, television receivers, lighting devices, toasters, and vehicles driven by electric power such as electric vehicles. For example, the present embodiment can be applied to plugs. In addition, the power receiving device according to the present embodiment may transmit electric power to the external connection device. In other words, the power receiving device according to the present embodiment may undertake the function of the power supply device.

(Program According to Present Embodiment)

1. Program According to Power Supply Device According to Present Embodiment

A program (for example, a program capable of executing the process related to the notice control method according to the present embodiment in the power supply device according to the present embodiment such as the process (1) (the determination process) to the process (3) (the notice control process)) causing a computer to function as the power supply device according to the present embodiment is executed in a computer so that the user can be notified of whether or not the external device connected via the power line supports a predetermined authentication function.

2. Program According to Power Receiving Device According to Present Embodiment

A program (for example, a program capable of executing the process related to the notice control method according to the present embodiment in the power receiving device according to the present embodiment such as the process (I) (the communication process) and the process (II) (the notice control process)) capable of causing a computer to function as the power receiving device according to the present embodiment is executed in a computer, and thus the user can be notified of whether or not the external device connected via the power line supports a predetermined authentication function.

It should be understood by those skilled in the art that various modifications, combinations, sub-combinations and alterations may occur depending on design requirements and other factors insofar as they are within the scope of the appended claims or the equivalents thereof.

For example, it has been described above that a program (computer program) causing a computer to function as the power supply device according to the present embodiment or the power receiving device according to the present embodiment is provided. However, in the present embodiment, a recording medium recording each program described above or a recording medium recording both programs can be provided as well.

The above-described configuration illustrates an example of the present embodiment, and it should be understood that the above-described configuration belongs to the technical scope of the present disclosure.

Additionally, the present technology may also be configured as below.

(C1) A power supply device, comprising:
a communication unit (104, 108) for performing communication with a power receiving device (200, 200A, 200B), wherein performing the communication includes transmitting a transmission signal to the device; a determining unit (122) for making a determination (S100) whether the device is a power supply target, based on a result of the communication; a power control unit (124) for controlling selective transmission (S102, S104) of power from a power supply unit (114) to the device via a power line (PL); and a notice control unit (126) for controlling provision of a notice indicating whether the device supports a predetermined authentication function.
(C2) The power supply device of (C1), wherein performing the communication with the device (200, 200A, 200B) further includes receiving a response signal, the device providing the response signal by performing load modulation based on the transmission signal.
(C3) The power supply device of (C2), wherein: the communication unit is a wireless communication unit (104), the wireless communication unit (104) comprises an antenna (152), the wireless communication unit is for transmitting the transmission signal through the antenna, and the transmission signal comprises a carrier wave.
(C4) The power supply device of (C4), wherein: the communication unit is a power line communication unit (108) for transmitting the transmission signal via the power line (PL), and the power supply device further comprises a first filter (110) for blocking a signal of a first frequency, the first filter being connected between the power line communication unit and the power line (PL).
(C5) The power supply device of any of (C1) to (C4), wherein: the communication unit is for transmitting the transmission signal at a first frequency; the power supply unit is for supplying the power at a second frequency; and the first frequency differs from the second frequency.
(C6) The power supply device of any of (C1) to (C5), further comprising a notifying unit (118) for providing the notice.
(C7) The power supply device of any of (C1) to (C6), further comprising a second communication unit (120) for transmitting control data to a second device, wherein the second device is for providing the notice.
(C8) The power supply device of any of (C6) to (C7), wherein: the notice is visual; and providing the notice comprises turning on a lamp.
(C9) The power supply device of (C8), wherein a color or a blinking of the lamp corresponds to a content of the notice.
(C10) The power supply device of any of (C6) to (C7), wherein: the notice is acoustical; and providing the notice comprises reproducing a sound corresponding to a content of the notice.
(C11) The power supply device of any of (C6) to (C7), wherein providing the notice comprises providing a first notice when the result of the determination indicates that the device (200, 200A, 200B) is the power supply target.
(C12) The method of any of (C6), (C7), or (C11), wherein providing the notice comprises providing a second notice when the result of the determination indicates that the device (200, 200A, 200B) is not the power supply target.
(C13) The power supply device of any of (C2) to (C5), wherein: the communication unit further comprises a demodulating unit (154, 158) for demodulating the response signal to obtain identification information of the device; and the determining unit (122) is for performing authentication of the device based on the identification information, wherein making the determination whether the device is the power supply target is further based on a result of the authentication.
(C14) The power supply device of any of (C1) to (C5), wherein making the determination whether the device is the power supply target comprises: determining that the device is not the power supply target when identification information is not acquired from the device.
(C15) The power supply device of any of (C1) to (C14), further comprising a connecting unit (102) for connecting the power line (PL) to the device (200, 200A, 200B).
(A1) A method comprising: performing communication with a device (200, 200A, 200B), wherein performing the communication includes transmitting a transmission signal to the device; based on a result of the communication, making a determination (S100) whether the device is a power supply target; based on a result of the determination, selectively transmitting (S102, S104) power from a power source to the device; and based on the result of the determination, providing a notice indicating whether the device supports a predetermined authentication function.
(A2) The method of (A1), wherein performing the communication with the device (200, 200A, 200B) further includes receiving a response signal, the response signal being provided by the device performing load modulation based on the transmission signal.
(A3) The method of (A2), wherein the transmission signal comprises a carrier wave transmitted through an antenna by a wireless communication unit (104).
(A4) The method of (A2), wherein the transmission signal is transmitted via a power line (PL) by a power line communication unit (108), the power line (PL) being connected to the power line communication unit by a first filter (110).
(A5) The method of any of (A1) to (A4), wherein: the transmission signal is transmitted at a first frequency; the power is supplied at a second frequency; and the first frequency differs from the second frequency.
(A6) The method of any of (A1) to (A5), wherein the notice is visual or acoustical.
(A7). The method of (A6), wherein providing the notice comprises turning on a lamp.
(A8) The method of (A7), wherein a color or a blinking of the lamp corresponds to a content of the notice.
(A9) The method of (A6), wherein providing the notice comprises reproducing a sound corresponding to a content of the notice.
(A10) The method of (A6), wherein providing the notice comprises providing a first notice when the result of the determination indicates that the device (200, 200A, 200B) is the power supply target.
(A11) The method of (A6) or (A10), wherein providing the notice comprises providing a second notice when the result of the determination indicates that the device (200, 200A, 200B) is not the power supply target.
(A12) The method of any of (A2) to (A5), further comprising: demodulating the response signal to obtain identification information of the device; and performing authentication of the device based on the identification information, wherein making the determination whether the device is the power supply target is further based on a result of the authentication.
(A13) The method of (A2), wherein making the determination whether the device is the power supply target comprises: determining that the device is not the power supply target when identification information is not acquired from the device.
(D1) A power receiving device, comprising: a communication unit (204, 208) for performing (S200) communication with a power supply device (100, 100A, 100B), wherein performing the communication includes determining whether the power supply device supports a predetermined authentication function; and a notifying unit (212) configured to provide (S202) a notice indicating whether the power supply device supports the predetermined authentication function, based on a result of the communication.
(D2) The power receiving device of (D1), wherein performing the communication with the power supply device further includes: receiving a transmission signal from the power supply device, wherein the transmission signal includes a request for transmission of identification information; and transmitting a response signal to the power supply device, wherein the response signal represents the identification information.
(D3) The power receiving device of (D2), wherein the communication unit (204, 208) further comprises a load modulation unit (264) for transmitting the response signal by load modulation.
(D4) The power receiving device of (D2), wherein: the communication unit is a wireless communication unit (204), the wireless communication unit comprises an antenna (250) for receiving the transmission signal, and the transmission signal comprises a carrier wave.
(D5) The power receiving device of (D2), wherein: the communication unit is a power line communication unit (208) for receiving the transmission signal via a power line (PL), and the power receiving unit further comprises a first filter (206) for blocking a signal of a first frequency, the first filter being connected between the power line communication unit and the power line (PL).
(D6) The power receiving device of any of (D1) to (D5), further comprising a second filter (210) for passing a power signal received from the power supply device via a power line (PL).
(D7) The power receiving device of any of (D1) to (D6), further comprising a notifying unit (212) for providing the notice.
(D8) The power receiving device of (D7), wherein the notifying unit (212) is driven by power obtained from the transmission signal or from the power line (PL).
(D9) The power receiving device of any of (D7) or (D8), wherein the notifying unit (212) comprises a display device, a digital signal processor, or an audio output device.
(B1) A method comprising: performing (S200) communication with a power supply device (100, 100A, 100B), wherein performing the communication includes determining whether the power supply device supports a predetermined authentication function; based on a result of the communication, providing (S202) a notice indicating whether the power supply device supports the predetermined authentication function.
(B2) The method of (B1), wherein performing the communication with the power supply device further includes: receiving a transmission signal from the power supply device, wherein the transmission signal includes a request for transmission of identification information; and transmitting a response signal to the power supply device, wherein the response signal represents the identification information.
(B3) The method of (B2), wherein transmitting the response signal comprises transmitting the response signal by load modulation.
(B4) The method of (B2), wherein receiving the transmission signal comprises receiving the transmission signal by an antenna (250) of a wireless communication unit (204), the transmission signal comprising a carrier wave.
(B5) The method of (B2), wherein receiving the transmission signal comprises receiving the transmission signal via a power line (PL) by a power line communication unit (208), the power line communication unit (208) being connected to the power line (PL) by a first filter (206).
(B6) The method of any of (B1) to (B5), further comprising receiving power transmitted from the power supply device via a power line (PL).
(B7) The method of (B1), wherein the notice is visual or acoustical.

### (E1)

A power supply device, including:
a connecting unit that connects a power line used to transmit power to an external device;
a communication unit that performs communication with an external connection device connected using a power line in a wired manner through the connecting unit, and acquires identification information representing the external connection device from the external connection device;
a determining unit that determines whether or not the external connection device is an external device of a power supply target based on a communication result with the external connection device and an authentication result of the external connection device which is based on the identification information when the identification information is acquired from the external connection device;
a power control unit that causes the power to be selectively transmitted to the external connection device when it is determined that the external connection device is the external device of the power supply target; and
a notice control unit that causes a notice to be made based on the determination result.

### (E2)

The power supply device according to (E1),
wherein the communication unit acquires the identification information transmitted when load modulation is performed in the external connection device.

### (E3)

The power supply device according to (E2),
wherein the communication unit includes
a power line communication unit that transmits a high-frequency signal having a frequency higher than a frequency of the power through the power line, and performs communication with the external connection device, and
a communication filter that is connected between the power line communication unit and the power line, blocks at least a signal having the frequency of the power, and does not block the high-frequency signal.

### (E4)

The power supply device according to (E2),
wherein the communication unit includes
a communication antenna that transmits a carrier wave according to a high-frequency signal having a frequency higher than a frequency of the power, and
a wireless communication unit that transmits the high-frequency signal through the communication antenna, and performs communication with the external connection device.

### (E5)

The power supply device according to (E1),
wherein the notice control unit causes different notices to be made when it is determined that the external connection device is the external device of the power supply target and when it is determined that the external connection device is not the external device of the power supply target.

### (E6)

The power supply device according to (E1), further including
a notifying unit that makes a notice based on the determination result,
wherein the notice control unit causes the notifying unit to make a notice based on the determination result.

### (E7)

A power receiving device, including:
a connecting unit that is connected to a power line used to transmit power;
a communication unit that performs communication with an external device connected using a power line in a wired manner through the connecting unit based on a connection to the power line; and
a notice control unit that causes a notice to be made based on a result of the communication related to authentication.

### (E8)

The power receiving device according to (E7),
wherein the communication unit performs communication with the external device by performing load modulation based on a signal transmitted from the external device.

### (E9)

The power receiving device according to (E8),
wherein the communication unit includes
a power line communication unit that performs communication with the external device through the power line by performing load modulation, and
a communication filter that is connected between the power line communication unit and the power line, blocks at least a signal having a frequency of the power, and does not block a high-frequency signal that has a frequency higher than the frequency of the power and is used for communication.

### (E10)

The power receiving device according to (E8),
wherein the communication unit includes
a communication antenna that receives a carrier wave according to a high-frequency signal having a frequency higher than a frequency of the power, which is transmitted from an external device, and
a wireless communication unit that performs communication with the external device through the communication antenna by performing load modulation.

### (E11)

The power receiving device according to (E7), further including
a notifying unit that makes a notice based on a result of the communication related to the authentication,
wherein the notice control unit causes the notifying unit to make a notice based on the result of the communication related to the authentication.

### (E12)

The power receiving device according to (E7), further including
a power supply unit that selectively blocks the power transmitted through the power line based on the communication result in the communication unit.

### (E13)

The power receiving device according to (E7),
wherein the power receiving device is a vehicle driven by electric power.

### (E14)

A program causing a computer to execute:
determining whether or not an external connection device is an external device of a power supply target based on a communication result with an external connection device connected using a power line used to transmit power in a wired manner, and an authentication result of the external connection device based on identification information representing the external connection device when the identification information is acquired from the external connection device; causing the power to be selectively transmitted to the external connection device when it is determined that the external connection device is the external device of the power supply target; and
causing a notice to be made based on the determination result.

### (E15)

A program causing a computer to execute:
performing communication with an external device connected using a power line used to transmit power in a wired manner based on a connection to the power line; and causing a notice to be made based on a result of the communication related to authentication.

### REFERENCE SIGNS LIST

100, 100A, 100B Power Supply Device
102, 202 Connecting Unit
104, 204 Wireless Communication Unit
106 Control Unit
108, 208 Power Line Communication Unit
110, 206 First Filter
112, 210 Second Filter
114 Power Supply Unit
116 Power Consumption Measuring Unit
118, 212 Notifying Unit
120 Communication Unit
122 Determining Unit
124 Power Control Unit
126 Notice Control Unit
200, 200A, 200B Power Receiving Device

1. A power supply device, comprising:
a communication unit for performing communication with a power receiving device, wherein performing the communication includes transmitting a transmission signal to the device;
a determining unit for making a determination whether the device is a power supply target, based on a result of the communication;
a power control unit for controlling selective transmission of power from a power supply unit to the device via a power line; and
a notice control unit for controlling provision of a notice indicating whether the device supports a predetermined authentication function.

2. The power supply device of claim 1, wherein performing the communication with the device further includes receiving a response signal, the device providing the response signal by performing load modulation based on the transmission signal.

3. The power supply device of claim 2, wherein:
the communication unit is a wireless communication unit,
the wireless communication unit comprises an antenna,
the wireless communication unit is for transmitting the transmission signal through the antenna, and
the transmission signal comprises a carrier wave.

4. The power supply device of claim 2, wherein:
the communication unit is a power line communication unit for transmitting the transmission signal via the power line, and
the power supply device further comprises a first filter for blocking a signal of a first frequency, the first filter being connected between the power line communication unit and the power line.

5. The power supply device of claim 1, wherein:
the communication unit is for transmitting the transmission signal at a first frequency;
the power supply unit is for supplying the power at a second frequency; and
the first frequency differs from the second frequency.

6. The power supply device of claim 1, further comprising a notifying unit for providing the notice.

7. The power supply device of claim 1, further comprising a second communication unit for transmitting control data to a second device, wherein the second device is for providing the notice.

8. The power supply device of claim 1, wherein:
the notice is visual; and providing the notice comprises turning on a lamp.

9. The power supply device of claim 8, wherein a color or a blinking of the lamp corresponds to a content of the notice.

10. The power supply device of claim 6 wherein:
the notice is acoustical; and providing the notice comprises reproducing a sound corresponding to a content of the notice.

11. The power supply device of claim 10, wherein providing the notice comprises providing a first notice when the result of the determination indicates that the device is the power supply target.

12. The power supply device of claimll, wherein providing the notice comprises providing a second notice when the result of the determination indicates that the device is not the power supply target.

13. The power supply device of claim 2, wherein:
the communication unit further comprises a demodulating unit for demodulating the response signal to obtain identification information of the device; and
the determining unit is for performing authentication of the device based on the identification information, wherein making the determination whether the device is the power supply target is further based on a result of the authentication.

14. The power supply device of claim 1, wherein making the determination whether the device is the power supply target comprises: determining that the device is not the power supply target when identification information is not acquired from the device.

15. The power supply device of claim 1, further comprising a connecting unit for connecting the power line to the device

16. A power receiving device, comprising:
a communication unit for performing communication with a power supply device, wherein performing the communication includes determining whether the power supply device supports a predetermined authentication function; and
a notifying unit for providing a notice indicating whether the power supply device supports the predetermined authentication function, based on a result of the communication.

17. The power receiving device of claim 16, wherein performing the communication with the power supply device further includes:
receiving a transmission signal from the power supply device, wherein the transmission signal includes a request for transmission of identification information; and
transmitting a response signal to the power supply device, wherein the response signal represents the identification information.

18. The power receiving device of claim 16, wherein the communication unit further comprises a load modulation unit for transmitting the response signal by load modulation.

19. The power receiving device of claim 18, wherein:
the communication unit is a wireless communication unit,
the wireless communication unit comprises an antenna for receiving the transmission signal, and
the transmission signal comprises a carrier wave.

20. The power receiving device of claim 18, wherein:
the communication unit is a power line communication unit for receiving the transmission signal via a power line, and
the power receiving unit further comprises a first filter for blocking a signal of a first frequency, the first filter being connected between the power line communication unit and the power line.

21. The power receiving device of claim 20, further comprising a second filter for passing a power signal received from the power supply device via a power line.

22. The power receiving device of claim 16, further comprising a notifying unit for providing the notice.

23. The power receiving device of claim 21, wherein the notifying unit is driven by power obtained from the transmission signal or from the power line.

24. The power receiving device of claim 22, wherein the notifying unit comprises a display device, a digital signal processor, or an audio output device.
